(19) United States
(12) Patent Application Publication
(10) Pub. No.: US 2009/0296562 A1
(43) Pub. Date: Dec. 3, 2009

(54) PHOTOELECTRIC CONVERTING DEVICE, AND OPTICAL DISK APPARATUS AND ADJUSTMENT METHOD OF THE SAME

(75) Inventors: Yasufumi SHIRAKAWA, Osaka (JP); Shinichi MIYAMOTO, Kyoto (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/474,830

(22) Filed: May 29, 2009

(30) Foreign Application Priority Data
Jun. 3, 2008 (JP) 2008-145320
Nov. 18, 2008 (JP) 2008-294974

(51) Int. Cl. G11B 7/00; G01J 1/44

(52) U.S. Cl. 369/120; 250/208.1; G9B/7

(57) ABSTRACT

Provided is a photoelectric converting device including: first photoreceptors each converting a received main beam to a current; second photoreceptors each converting a received first sub-beam to a current; and third photoreceptors each converting a received second sub-beam to a current; first current-voltage converting circuits each converting the current converted by a corresponding one of the first photoreceptors to a voltage; current amplifying circuits each amplifying or attenuating the current converted by a corresponding one of the second photoreceptors; switching circuits each supplying one of the current amplified or attenuated by a corresponding one of the current amplifying circuits and the current converted by the corresponding one of the second photoreceptors; and second current-voltage converting circuits each converting a sum of the current supplied by a corresponding one of the switching circuits and the current converted by a corresponding one of the third photoreceptors to a voltage.

### BACKGROUND OF THE INVENTION

(1) Field of the Invention

The present invention relates to a photoelectric converting device, and an optical disk apparatus and an adjustment method of the same, and in particular to a photoelectric converting device that receives a first main beam, a first sub-beam, and a second sub-beam that are emitted from a light source and reflected from an optical disk.

(2) Description of the Related Art

Conventionally, optical disk apparatuses that read data recorded on optical disks, such as a compact disk (CD), a Digital Versatile Disk (DVD), and a Blu-ray Disk (BD), or that write data on an optical disk use an optical pickup device that generates a tracking error signal and a focus error signal. When the optical pickup devices generate a tracking error signal and a focus error signal, the three beam method using a main beam and two sub-beams, and the differential astigmatism method are used (for example, see Japanese Unexamined Patent Application Publication No. 2007-87459).

The following describes a conventional photoelectric converting device (optical pickup device) included in an optical disk apparatus.

FIG. 13 schematically illustrates a spot 502 of a main beam, a spot 503 of a first sub-beam, and a spot 504 of a second sub-beam. Here, the main beam, the first sub-beam, and the second sub-beam are emitted on a surface of an optical disk 501. Here, the main beam, the first sub-beam, and the second sub-beam are beams obtained by splitting, using a diffraction grating, a light beam emitted from a light source, such as a laser device. As illustrated in FIG. 13, the spot 503 of the first sub-beam and the spot 504 of the second sub-beam are displaced by half a track pitch Tp with respect to the spot 502 of the main beam in a radial direction.

FIG. 14 illustrates a configuration of a conventional photoelectric converting device 500. The photoelectric converting device 500 in FIG. 14 receives a beam reflected from the optical disk 501, and converts the received beam to electric signals to generate light-receiving signals A to H, E+I, F+J, G+K, and H+L. Here, the light-receiving signals A to D are signals each corresponding to data to be recorded on the optical disk 501, and the light-receiving signals E+I, F+J, G+K, and H+L are signals for generating a tracking error signal and a focus error signal. The photoelectric converting device 500 includes photoreceptor groups 101 to 103, current-voltage converting circuits 111a to 111h, and a switch 512.

The first photoreceptor group 101 receives a main beam emitted onto the spot 502 illustrated in FIG. 13 and reflected from the optical disk 501. The first photoreceptor group 101 includes 4 photoreceptors 110a to 110d. The second photoreceptor group 102 receives the first sub-beam emitted onto the spot 503 and reflected from the optical disk 501. The second photoreceptor group 102 includes 4 photoreceptors 110e to 110h. The third photoreceptor group 103 receives the second sub-beam emitted onto the spot 504 and reflected from the optical disk 501. The third photoreceptor group 103 includes 4 photoreceptors 110i to 110l. Furthermore, each of the photoreceptors 110a to 110l performs photoelectric conversion to convert the received beam to a current.

The current-voltage converting circuits 111a to 111d respectively convert the currents obtained from the photoreceptors 110a to 110d to voltages to generate the light-receiving signals A to D.

The photoreceptors 110e to 110h are respectively connected to input terminals of the current-voltage converting circuits 111e to 111h. Furthermore, the photoreceptors 110i to 110l are also respectively connected to input terminals of the current-voltage converting circuits 111e to 111h through the switch 512. The current-voltage converting circuits 111e to 111h respectively convert the input currents to voltages to generate the light-receiving signals E to H, or the light-receiving signals E+I, F+J, G+K, and H+L.

Here, the light-receiving signals A to H are signals respectively corresponding to intensity of the beams received by the photoreceptors 110a to 110h. Furthermore, the light-receiving signals E+I is a signal corresponding to a sum of the intensity of the beam received by the photoreceptor 110e and intensity of the beam received by the photoreceptors 110i, and the light-receiving signals F+J, G+K, and H+L are also signals respectively corresponding to sums of (i) the intensity of the beams received by the photoreceptors 110f, 110g, and 110h and (ii) intensity of the beams received by the photoreceptors 110j, 110k, and 110l.

Next, the operations of the photoelectric converting device 500 will be described.

First, the operations of the photoelectric converting device 500 when the optical disk apparatus reproduces data recorded on the optical disk 501 or records data on the optical disk 501 will be described.

Here, the switch 512 is turned on. With the switch 512 turned on, the photoreceptors 110i to 110l included in the third photoreceptor group 103 are electrically connected to the input terminals of the current-voltage converting circuits 111e to 111h, respectively. Thus, a sum of the current photoelectric-converted by the photoreceptor 110e included in the second photoreceptor group 102 and the current photoelectric-converted by the photoreceptor 110i included in the third photoreceptor group 103 is provided to the current-voltage converting circuit 111e. In the same manner, sums of the currents photoelectric-converted by the photoreceptors 110f, 110g, and 110h included in the second photoreceptor group 102 and the currents photoelectric-converted by the photoreceptors 110j, 110k, and 110l included in the third photoreceptor group 103 are respectively provided to the current-voltage converting circuits 111f, 111g, and 111h. The current-voltage converting circuits 111e to 111h respectively convert the input currents to voltages to generate the light-receiving signals E+I, F+J, G+K, and H+L and transmit the generated light-receiving signals E+I, F+J, G+K, and H+L, when the switch 512 is turned on.

Furthermore, current signals obtained by the photoreceptors 110a to 110d included in the first photoreceptor group 101 are respectively provided to the current-voltage converting circuits 111a to 111d. The current-voltage converting circuits 111a to 111d respectively convert input currents corresponding to the current signals to voltages to generate the light-receiving signals A to D and transmit the generated light-receiving signals A to D.

These light-receiving signals A to D, E+I, F+J, G+K, and H+L are transmitted to an RF signal processing circuit that is included in the optical disk apparatus and is installed in a latter stage of the photoelectric converting device 500, but is not illustrated in FIG. 14. Using the light-receiving signals A to D, E+I, F+J, G+K, and H+L, the RF signal processing circuit calculates, for example, a focus error signal FE using the differential astigmatism method, and a tracking error signal TE using the differential push-pull method. For example, the RF signal processing circuit calculates the focus error signal FE and the tracking error signal TE using Equations (1) and (2) below. In Equations (1) and (2), k1 and k2 are predetermined coefficients.

FE=(A+C)−(B+D)+k1[(E+I+G+K)−(F+J+H+L)] Equation (1)

TE=(A+B)−(C+D)+k2[(E+I+F+J)−(G+K+H+L)] Equation (2)

Next, the operations of the photoelectric converting device 500 when (i) a configuration of an optical system included in the optical disk apparatus and (ii) a position of the photoelectric converting device are adjusted will be described.

Here, the switch 512 is turned off. With the switch 512 turned off, the photoreceptors 110i to 110l included in the third photoreceptor group 103 are respectively insulated from the input terminals of the current-voltage converting circuits 111e to 111h. Since the current photoelectric-converted by the photoreceptor 110i included in the third photoreceptor group 103 is not provided to the current-voltage converting circuit 111e, only the current photoelectric-converted by the photoreceptor 110e included in the second photoreceptor group 102 is provided to the current-voltage converting circuit 111e. In the same manner, since the currents photoelectric-converted by the photoreceptors 110j, 110k, and 110l included in the third photoreceptor group 103 are not respectively provided to the current-voltage converting circuits 111f, 111g, and 111h, only the currents photoelectric-converted by the photoreceptors 110f, 110g, and 110h included in the second photoreceptor group 102 are respectively provided to the current-voltage converting circuits 111f, 111g, and 111h. The current-voltage converting circuits 111e to 111h respectively convert the input currents to voltages to generate the light-receiving signals E to H and transmit the generated light-receiving signals E to H, when the switch 512 is turned off.

Furthermore, the current signals obtained by the photoreceptors 110a to 110d included in the first photoreceptor group 101 are respectively provided to the current-voltage converting circuits 111a to 111d. The current-voltage converting circuits 111a to 111d respectively convert input currents corresponding to the current signals to voltages to generate the light-receiving signals A to D and transmit the generated light-receiving signals A to D.

Here, the middle of spot positions of the main beam, the first sub-beam, and the second sub-beam that are emitted on the photoelectric converting device 500 can respectively match the middle of the photoreceptor groups 101, 102, and 103 by adjusting the configuration of the optical system and the position of the photoelectric converting device 500 to satisfy conditions of (i) the light-receiving signals A=B=C=D and (ii) the light-receiving signals E=F=G=H.

However, when adjusting the configuration of the optical system included in the optical disk apparatus and the position of the photoelectric converting device 500, the conventional photoelectric converting device 500 has the following problems.

The light intensity of the first and second sub-beams is smaller than that of the main beam. Thus, gains of the current-voltage converting circuits 111e to 111h are generally set larger than gains of the current-voltage converting circuits 111a to 111d. Accordingly, offset voltages occurring in the current-voltage converting circuits 111e to 111h become larger than offset voltages occurring in the current-voltage converting circuits 111a to 111d. In other words, the light-receiving signals E to H include the offset voltages larger than the offset voltages included in the light-receiving signals A to D.

Since the light-receiving signals E to H include the larger offset voltages, the precision of centering the sub-beams becomes inferior to the precision of centering the main beam when the configuration of the optical system and the position of the photoelectric converting device 500 are adjusted to satisfy the conditions of (i) the light-receiving signals A=B=C=D and (ii) the light-receiving signals E=F=G=H. Thus, there occurs a problem that the precision of adjusting the angular displacement of an angle around an axis becomes lower. Here, the axis passes through the middle of the spot 502 of the main beam, and is vertical to a surface of the optical disk 501.

### SUMMARY OF THE INVENTION

As such, the conventional photoelectric converting device 500 has a problem that the precision of adjusting a sub-beam becomes lower.

Thus, the present invention has an object of providing a photoelectric converting device, and an optical disk apparatus and an adjustment method of the same so as to improve the precision of adjusting a sub-beam.

In order to achieve the object, the photoelectric converting device according to the present invention is a photoelectric converting device that receives a first main beam, a first sub-beam, and a second sub-beam that are emitted from a light source and reflected from an optical disk, the photoelectric converting device including: first photoreceptors each of which receives the reflected first main beam, and converts the received first main beam to a current; second photoreceptors each of which receives the reflected first sub-beam, and converts the received first sub-beam to a current; third photoreceptors each of which receives the reflected second sub-beam, and converts the received second sub-beam to a current; first current-voltage converting circuits which respectively correspond to the first photoreceptors, and each of which converts the current converted by a corresponding one of the first photoreceptors to a voltage, and supplies the resulting voltage outside the photoelectric converting device; current amplifying circuits which respectively correspond to the second photoreceptors, and each of which amplifies or attenuates the current converted by a corresponding one of the second photoreceptors; switching circuits which respectively correspond to the second photoreceptors and the current amplifying circuits, and each of which supplies one of (i) the current converted by the corresponding one of the second photoreceptors and (ii) the current amplified or attenuated by a corresponding one of the current amplifying circuits; and second current-voltage converting circuits which respectively correspond to the third photoreceptors and the switching circuits, and each of which converts a sum of (i) the current supplied by a corresponding one of the switching circuits and (ii) the current converted by a corresponding one of the third photoreceptors to a voltage, and supplies the resulting voltage outside the photoelectric converting device.

With this configuration, the photoelectric converting device according to the present invention generates a signal corresponding to a sum of intensity of the first sub-beam and the second sub-beam respectively received by the second photoreceptor and the third photoreceptor, and a signal corresponding to a sum of (i) intensity obtained by amplifying or attenuating the first sub-beam received by the second photoreceptor and (ii) intensity of the second sub-beam received by the third photoreceptor. Thereby, an offset voltage occurring in the second current-voltage converting circuit can be cancelled, by subtracting a signal from another signal that are both generated by the photoelectric converting device. Thus, the photoelectric converting device can improve the precision of adjusting a sub-beam.

Furthermore, each of the current amplifying circuits may include a current mirror circuit which multiplies, by N, the current converted by the corresponding one of the second photoreceptors, invert a phase of the current multiplied by N, and supply the inverted current, where N is larger than 0, and each of the switching circuits may supply one of (i) the current converted by the corresponding one of the second photoreceptors and (ii) the current supplied by a corresponding one of the current mirror circuits.

Furthermore, each of the current amplifying circuits may further include a first current source which is connected to an input terminal of a corresponding one of the current mirror circuits, and which supplies a current that flows in a direction identical to a direction of the current converted by a corresponding one of the second photoreceptors.

With this configuration, the current amplifying circuit can respond faster.

Furthermore, each of the current amplifying circuits may further include a second current source which is connected to an output terminal of a corresponding one of the current mirror circuits, and which supplies a current that flows in a direction opposite to a direction of the current that is supplied by the corresponding one of the current mirror circuits and that is a current obtained by multiplying, by N, the current supplied by a corresponding one of the first current sources.

With this configuration, the second current source can cancel the current supplied by the first current source. Thereby, the increase in the offset voltage occurring in the second current-voltage converting circuit due to the current supplied by the first current source can be suppressed.

Furthermore, the light source may emit, to the optical disk, (i) the first main beam, the first sub-beam, and the second sub-beam each having a first wavelength, and (ii) a second main beam, a third sub-beam, and a fourth sub-beam each having a second wavelength different from the first wavelength, the photoelectric converting device may have a first operating mode and a second operating mode, the photoelectric converting device further may include: fourth photoreceptors each of which receives the second main beam that is emitted from the light source and is reflected from the optical disk, and converts the received second main beam to a current; fifth photoreceptors each of which receives the third sub-beam that is emitted from the light source and is reflected from the optical disk, and converts the received third sub-beam to a current; sixth photoreceptors each of which receives the fourth sub-beam that is emitted from the light source and is reflected from the optical disk, and converts the received fourth sub-beam to a current; first switches which respectively correspond to the first photoreceptors and the fourth photoreceptors, and each of which supplies the current converted by the corresponding one of the first photoreceptors in the first operating mode, and supplies the current converted by a corresponding one of the fourth photoreceptors in the second operating mode; second switches which respectively correspond to the second photoreceptors and the fifth photoreceptors, and each of which supplies the current converted by the corresponding one of the second photoreceptors in the first operating mode, and supplies the current converted by a corresponding one of the fifth photoreceptors in the second operating mode; and third switches which respectively correspond to the third photoreceptors and the sixth photoreceptors, and each of which supplies the current converted by the corresponding one of the third photoreceptors in the first operating mode, and supplies the current converted by a corresponding one of the sixth photoreceptors in the second operating mode, each of the first current-voltage converting circuits may convert the current supplied by a corresponding one of the first switches to a voltage, and supply the resulting voltage outside the photoelectric converting device, each of the current amplifying circuits may amplify or attenuate the current supplied by a corresponding one of the second switches, each of the switching circuits may supply one of (i) the current supplied by the corresponding one of the second switches and (ii) the current amplified or attenuated by the corresponding one of the current amplifying circuits, each of the second current-voltage converting circuits may convert a sum of (i) the current supplied by the corresponding one of the switching circuits and (ii) the current supplied by a corresponding one of the third switches to a voltage, and supply the resulting voltage outside the photoelectric converting device, and each of the first current sources may supply a current having a first current value in the first operating mode, and a current having a second current value in the second operating mode, the second current value being larger than the first current value.

With this configuration, the first current source can supply currents having different current values respectively in the first operating mode and the second operating mode. Here, although the current amplifying circuit can respond faster when the current value of the current supplied by the first current source is larger, there is a disadvantage of increase in the offset voltage, noise, and others. Thus, the photoelectric converting device can reduce the influence of the offset voltage, noise, and others by lowering the current value of the first current source in a mode in which the current amplifying circuit does not have to respond faster.

Furthermore, each of the second current-voltage converting circuits may convert a sum of (i) the current supplied by the corresponding one of the switching circuits and (ii) the current supplied by the corresponding one of the third switches to a voltage according to a first current-voltage conversion gain in the first operating mode, and may convert a sum of (i) the current supplied by the corresponding one of the switching circuits and (ii) the current supplied by the corresponding one of the third switches to a voltage according to a second current-voltage conversion gain in the second operating mode, the second current-voltage conversion gain being smaller than the first current-voltage conversion gain.

With this configuration, the second current-voltage converting circuit can adjust the current-voltage conversion gain using the first operating mode and the second operating mode. Furthermore, the second current-voltage converting circuit uses a smaller current-voltage conversion gain in the second operating mode in which the first current source supplies a current having a larger current value. Thereby, the fluctuations of the offset voltage occurring due to the switching operation in the second current-voltage converting circuit can be suppressed.

Furthermore, each of the current amplifying circuits may include: a first current mirror circuit which amplifies or attenuates the current converted by the corresponding one of the second photoreceptors, and inverts a phase of the resulting current, and supplies the inverted current; and a second current mirror circuit which inverts the phase of the current supplied by the first current mirror circuit, and supplies the inverted current, and each of the switching circuits may supply one of (i) the current converted by a corresponding one of the second photoreceptors and (ii) the current supplied by a corresponding one of the second current mirror circuits.

Furthermore, each of the current amplifying circuits may include: a differential amplifier including an inverting input terminal, a non-inverting input terminal, and an output terminal; a first resistor which is connected between the inverting input terminal and the output terminal of the differential amplifier; and a second resistor which is connected between the non-inverting input terminal and the output terminal of the differential amplifier, each of the inverting input terminals of the differential amplifiers may receive the current converted by the corresponding one of the second photoreceptors, and each of the current amplifying circuits may supply the amplified or attenuated current to a corresponding one of the non-inverting input terminals of the differential amplifiers.

With this configuration, the gain of the current amplifying circuit can be easily not less than 1.

Furthermore, each of the differential amplifiers may further include: a first MOS transistor connected to a gate of a corresponding one of the inverting input terminals of the differential amplifiers; and a second MOS transistor connected to a gate of the corresponding one of the non-inverting input terminals of the differential amplifiers.

With this configuration, a current amount to flow to the inverting input terminal and the non-inverting input terminal of the differential amplifier can be reduced. Thereby, the offset voltage occurring in the second current-voltage converting circuit can be reduced.

Furthermore, the optical disk apparatus according to the present invention is an optical disk apparatus that performs at least one operation of writing data on an optical disk and reading data recorded on the optical disk, the optical disk apparatus including: the photoelectric converting device; a light source that emits a beam; and an optical system which splits the beam emitted by the light source into the first main beam, the first sub-beam, and the second sub-beam, and guides (i) the first main beam, the first sub-beam, and the second sub-beam that have been split to the optical disk, and (ii) the first main beam, the first sub-beam, and the second sub-beam that have been reflected from the optical disk to the photoelectric converting device.

With this configuration, the photoelectric converting device according to the present invention generates a signal corresponding to a sum of intensity of the first sub-beam and the second sub-beam respectively received by the second photoreceptor and the third photoreceptor, and a signal corresponding to a sum of (i) intensity obtained by amplifying or attenuating the first sub-beam received by the second photoreceptor and (ii) intensity of the second sub-beam received by the third photoreceptor. Thereby, an offset voltage occurring in the second current-voltage converting circuit can be cancelled, by subtracting a signal from another signal that are both generated by the photoelectric converting device. Thus, the photoelectric converting device can improve the precision of adjusting a sub-beam.

Furthermore, the adjustment method of the optical disk apparatus according to the present invention is an adjustment method, for use in the optical disk apparatus, for adjusting spot positions of a first sub-beam and a second sub-beam that are reflected from the optical disk and are emitted on the photoelectric converting device, the adjustment method including: converting, using each of the second current-voltage converting circuits, a sum of (i) the current converted by the corresponding one of the second photoreceptors and (ii) the current converted by a corresponding one of the third photoreceptors to a first voltage signal, and transmitting the first voltage signal when each of the switching circuits selects the current converted by the corresponding one of the second photoreceptors; converting, using each of the second current-voltage converting circuits, a sum of (i) the current obtained by amplifying or attenuating the current converted by the corresponding one of the second photoreceptors and (ii) the current converted by the corresponding one of the third photoreceptors to a second voltage signal, and transmitting the second voltage signal when each of the switching circuits selects the current amplified or attenuated by a corresponding one of the current amplifying circuits; calculating a subtraction signal for each of the second current-voltage converting circuits by subtracting the first voltage signal from the second voltage signal or the second voltage signal from the first voltage signal, the first voltage signal and the second voltage signal being supplied by a same one of the second current-voltage converting circuits; and adjusting at least one of a configuration of the optical system and a position of the photoelectric converting device using the subtraction signals so that the spot position of the first sub-beam reflected from the optical disk is in a middle of the second photoreceptors and the spot position of the second sub-beam reflected from the optical disk is in a middle of the third photoreceptors.

Thereby, with the adjustment method of the optical disk apparatus according to the present invention, generated is a signal corresponding to a sum of intensity of the first sub-beam and the second sub-beam respectively received by the second photoreceptor and the third photoreceptor, and a signal corresponding to a sum of (i) intensity obtained by amplifying or attenuating the first sub-beam received by the second photoreceptor and (ii) intensity of the second sub-beam received by the third photoreceptor. Furthermore, the adjustment method can cancel an offset voltage occurring in the second current-voltage converting circuit, by subtracting a signal from another signal that are both generated by the photoelectric converting device. Thus, the photoelectric converting device can improve the precision of adjusting a sub-beam.

Thus, the present invention can provide a photoelectric converting device, and an optical disk apparatus and an adjusting method of the same so as to improve the precision of adjusting a sub-beam.

### FURTHER INFORMATION ABOUT TECHNICAL BACKGROUND TO THIS APPLICATION

The disclosure of Japanese Patent Application No. 2008-145320 filed on Jun. 3, 2008 and the disclosure of Japanese Patent Application No. 2008-294974 filed on Nov. 18, 2008 each including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 illustrates the configuration of the optical disk apparatus according to Embodiment 1;

FIG. 2 illustrates the configuration of the photoelectric converting device according to Embodiment 1;

FIG. 3 is a flowchart showing the adjustment operations using the photoelectric converting device according to Embodiment 1;

FIG. 4 illustrates a circuit configuration of the switching circuit according to Embodiment 1;

FIG. 5 illustrates a circuit configuration of a variation of the switching circuit according to Embodiment 1;

FIG. 6 illustrates a circuit configuration of a variation of the switching circuit according to Embodiment 1;

FIG. 7 illustrates a specific example of the switching circuit according to Embodiment 1;

FIG. 8 illustrates a configuration of the photoelectric converting device according to Embodiment 2;

FIG. 9 illustrates a configuration of the switching circuit according to Embodiment 2;

FIG. 10 illustrates a circuit configuration of a variation of the current-voltage converting circuit according to Embodiment 2;

FIG. 11 illustrates a circuit configuration of the switching circuit according to Embodiment 3;

FIG. 12 illustrates a configuration of the switching circuit according to Embodiment 3;

FIG. 13 illustrates a positional relationship among 3 spots for implementing the three beam method and differential astigmatism method; and

FIG. 14 illustrates a configuration of a conventional photoelectric converting device.

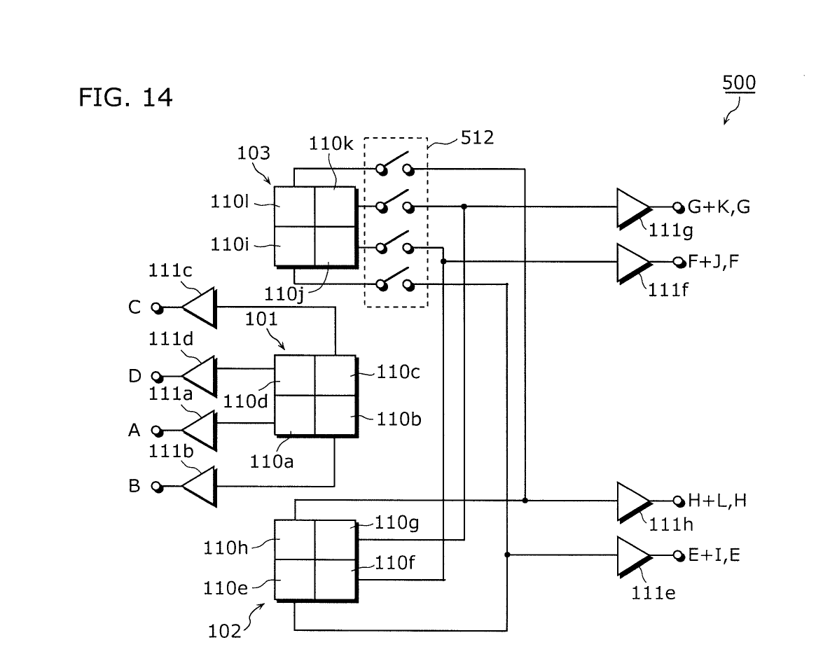

### DESCRIPTION OF THE PREFERRED EMBODIMENTS

Embodiments of the photoelectric converting device according to the present invention will be described in detail with reference to the drawings.

### Embodiment 1

A photoelectric converting device according to Embodiment 1 provides a first signal corresponding to a sum of intensity of the first and second sub-beams, and a second signal corresponding to a sum of intensity obtained by multiplying the first sub-beam by N and the intensity of the second sub-beam. Thus, the precision of adjusting a sub-beam can be improved by subtracting the first signal from the second signal or the second signal from the first signal to cancel an offset voltage occurring in a current-voltage converting circuit.

First, a configuration of an optical disk apparatus 10 including a photoelectric converting device 100 according to Embodiment 1 of the present invention will be described.

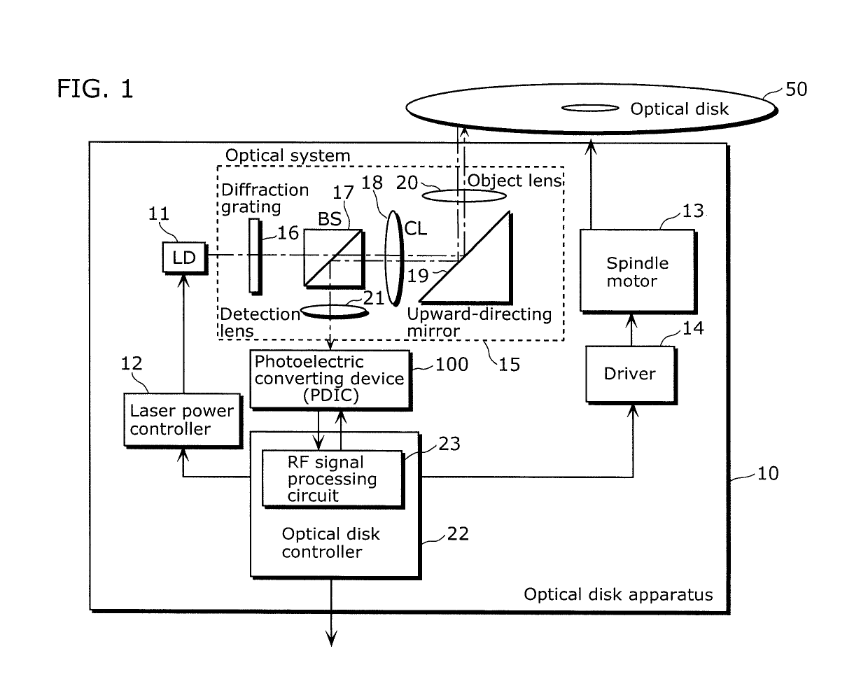

FIG. 1 illustrates a configuration of the optical disk apparatus 10.

The optical disk apparatus 10 illustrated in FIG. 1 reads data recorded on an optical disk 50, and writes data on the optical disk 50. The optical disk 50 is, for example, a CD, a DVD, or a BD.

The optical disk apparatus 10 includes a laser device (LD) 11, a laser power controller 12, a spindle motor 13, a driver 14, an optical system 15, an optical disk controller 22, and the photoelectric converting device 100.

The optical disk controller 22 controls the LD 11 and the spindle motor 13. In other words, the optical disk controller 22 performs focus and tracking control. The optical disk controller 22 includes an RF signal processing circuit 23.

The LD 11 is a light source that generates a beam to be emitted on the optical disk 50. The laser power controller 12 controls the intensity of a beam emitted by the LD 11 under the control of the optical disk controller 22.

The spindle motor 13 performs an angular displacement under the control of the optical disk controller 22 via the driver 14.

The optical system 15 splits the beam emitted by the LD 11 into a main beam, a first sub-beam, and a second sub-beam, and guides the main beam, the first sub-beam, and the second sub-beam to the optical disk 50. Furthermore, the optical system 15 guides the main beam, the first sub-beam, and the second sub-beam that have been emitted by the LD 11 and reflected from the optical disk 50 to the photoelectric converting device 100. The optical system 15 includes a diffraction grating 16, a beam splitter (BS) 17, a collimator lens (CL) 18, an upward-directing mirror 19, an object lens 20, and a detection lens 21.

The diffraction grating 16 splits the beam emitted by the LD 11 into the main beam, the first sub-beam, and the second sub-beam.

The main beam, the first sub-beam, and the second sub-beam split by the diffraction grating 16 are directed by the upward-directing mirror 19 upward through the BS 17 and the CL 18, and are converged by the object lens 20 to be emitted on the optical disk 50.

After being reflected from the optical disk 50, the main beam, the first sub-beam, and the second sub-beam are emitted to the photoelectric converting device 100 sequentially through the object lens 20, the upward-directing mirror 19, the CL 18, the BS 17, and the detection lens 21.

The photoelectric converting device 100 is a Photo Detector IC (PDIC) that is an LSI for an optical pickup device. The photoelectric converting device 100 receives the main beam, the first sub-beam, and the second sub-beam that are emitted from the LD 11 and reflected from the optical disk 50. Furthermore, the photoelectric converting device 100 generates light-receiving signals that are electric signals by performing photoelectric conversion on the received main beam, the first sub-beam, and the second sub-beam, and provides the generated light-receiving signals to the RF signal processing circuit 23.

Furthermore, the photoelectric converting device 100 has a first operating mode and a second operating mode, and provides different light-receiving signals in the first operating mode and the second operating mode.

More specifically, the photoelectric converting device 100 operates in the first operating mode, when the optical disk apparatus 10 reproduces data recorded on the optical disk 50, or records data on the optical disk 50 (these operations are collectively referred to as a normal operation hereinafter). Furthermore, the photoelectric converting device 100 operates in the second operating mode after the first operating mode, when adjusting the spot positions of the main beam, the first sub-beam, and the second sub-beam that are emitted on the photoelectric converting device 100 (referred to as the adjustment operation hereinafter), respectively. The adjustment operation is performed, for example, in manufacturing (assembling) or shipping the optical disk apparatus 10. Furthermore, the spot positions of the main beam, the first sub-beam, and the second sub-beam that are emitted on the photoelectric converting device 100 are adjusted by adjusting the configuration of the optical system 15 included in the optical disk apparatus 10 and the position of the photoelectric converting device 10.

More specifically, in the first operating mode, the photoelectric converting device 100 generates a signal corresponding to data recorded onto the optical disk 50, and a signal for performing focus and tracking control. Furthermore, in the second operating mode, the photoelectric converting device 100 generates a signal corresponding to data recorded onto the optical disk 50, and a signal for adjusting the configuration of the optical system 15 and the position of the photoelectric converting device 100. Furthermore, a signal that is provided in the first and second operating modes and that corresponds to data recorded onto the optical disk 50 is used for adjusting the main beam. Furthermore, a signal that is provided in the first operating mode and is for performing focus and tracking control is used for adjusting the first and second sub-beams.

Furthermore, the optical disk controller 22 switches between the first and second operating modes. Furthermore, the optical disk controller 22 switches between the first and second operating modes according to an input from outside the optical disk apparatus 10.

The RF signal processing circuit 23 shapes a waveform of the light-receiving signal generated by the photoelectric converting device 100, and performs signal processing on the light-receiving signal. More specifically, the RF signal processing circuit 23 calculates, for example, a focus error signal FE using the differential astigmatism method, and a tracking error signal TE using the differential push-pull method.

The optical disk controller 22 performs focus control using the focus error signal FE, and tracking control using the tracking error signal TE. Furthermore, the optical disk controller 22 transmits a signal in which the signal processing has been performed by the RF signal processing circuit 23 and which corresponds to data recorded on the optical disk 50, and a signal for adjusting the configuration of the optical system 15 and the position of the photoelectric converting device 100, outside the optical disk apparatus 10.

Next, a configuration of the photoelectric converting device 100 will be described.

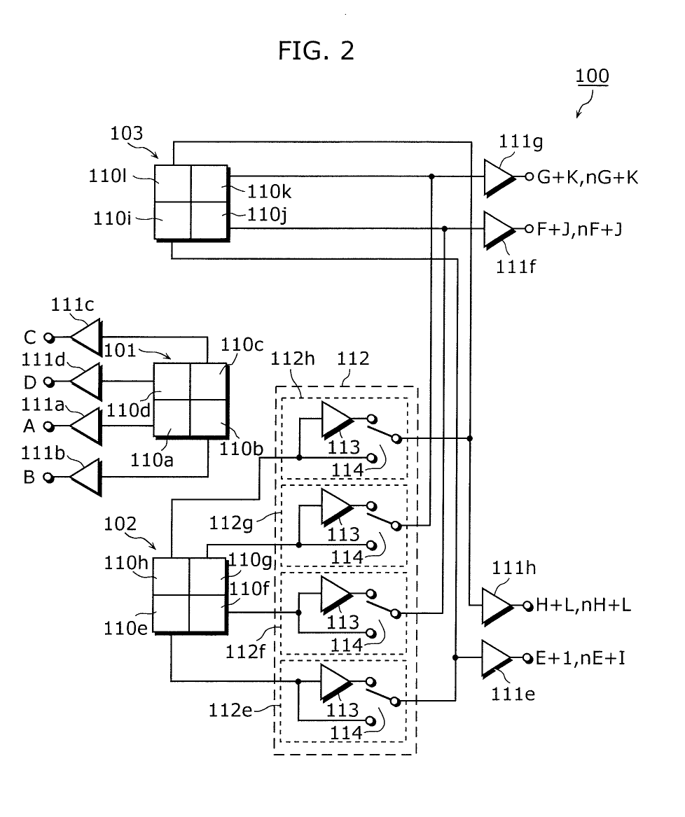

FIG. 2 illustrates the configuration of the photoelectric converting device 100. The photoelectric converting device 100 includes photoreceptor groups 101 to 103, current-voltage converting circuits 111a to 111h, and a switching circuit group 112.

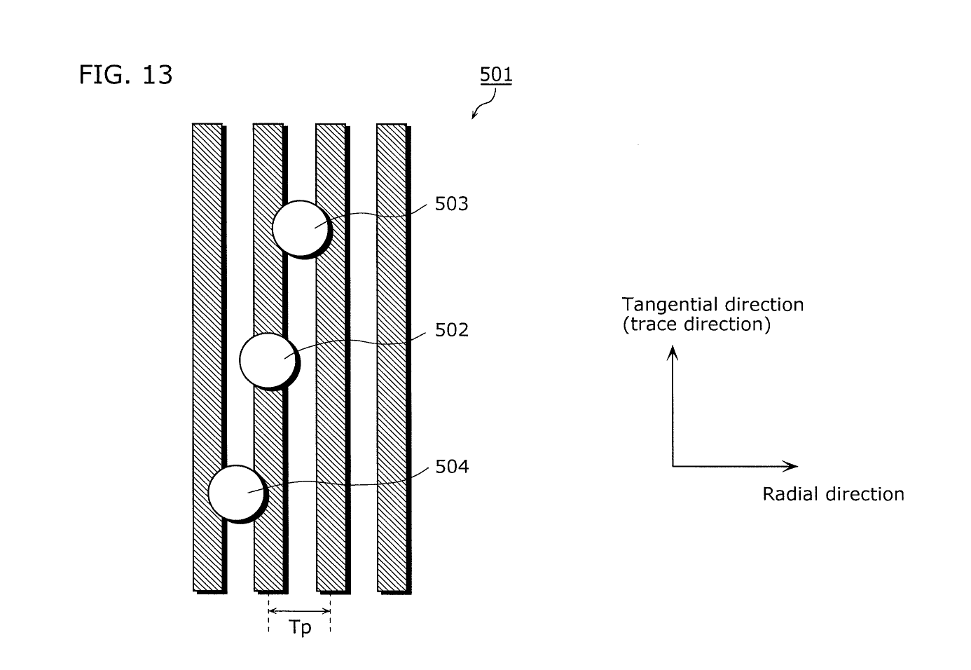

The first photoreceptor group 101 receives a main beam emitted on the spot 502 illustrated in FIG. 13 and reflected from the optical disk 50. The first photoreceptor group 101 includes 4 photoreceptors 110a to 110d that are adjacent to each other.

The second photoreceptor group 102 receives a first sub-beam emitted on the spot 503 and reflected from the optical disk 50. The second photoreceptor group 102 includes 4 photoreceptors 110e to 110h that are adjacent to each other.

The third photoreceptor group 103 receives a second sub-beam emitted on the spot 504 and reflected from the optical disk 50. The third photoreceptor group 103 includes 4 photoreceptors 110i to 110l that are adjacent to each other.

Each of the photoreceptors 110a to 110l performs photoelectric conversion to convert the received beam to a photoelectric current according to the intensity of the beam (amount of light).

The photoreceptors 110a to 110d are respectively connected to the input terminals of the current-voltage converting circuits 111a to 111d. The current-voltage converting circuits 111a to 111d respectively convert the currents photoelectric-converted by the photoreceptors 110a to 110d to voltages to generate the light-receiving signals A to D and transmit the generated light-receiving signals A to D. Here, the light-receiving signals A to D are signals respectively corresponding to intensity of the main beams received by the photoreceptors 110a to 110d.

The switching circuit group 112 includes switching circuits 112e to 112h respectively corresponding to the photoreceptors 110e to 110h. Each of the switching circuits 112e to 112h includes a current amplifying circuit 113 and a switch 114.

Each of the current amplifying circuits 113 multiplies, by N, the current photoelectric-converted by a corresponding one of the photoreceptors 110e to 110h. Here, N is typically a figure less than 1 and larger than 0. In other words, each of the current amplifying circuits 113 attenuates the current photoelectric-converted by a corresponding one of the photoreceptors 110e to 110h. Here, N may be 1 or more. In other words, each of the current amplifying circuits 113 may amplify the current photoelectric-converted by a corresponding one of the photoreceptors 110e to 110h.

Each of the switches 114 selects one of (i) the current multiplied by N by a corresponding one of the current amplifying circuits 113 and (ii) the current photoelectric-converted by a corresponding one of the photoreceptors 110e to 110h, and supplies the selected current to a corresponding one of the current-voltage converting circuits 111e to 111h. More specifically, each of the switches 114 selects the current photoelectric-converted by a corresponding one of the photoreceptors 110e to 110h in a one-time mode (first operating mode), and the current multiplied by N by the corresponding one of the current amplifying circuits 113 in an N-time mode (second operating mode).

The photoreceptors 110i to 110l are respectively connected to the input terminals of the current-voltage converting circuits 111e to 111h. Furthermore, the photoreceptors 110i to 110l are respectively connected to the input terminals of the current-voltage converting circuits 111e to 111h through the switching circuit group 112. The current-voltage converting circuit 111e converts, to a voltage, a sum of a current provided by the switching circuit 112e and a current photoelectric-converted by the photoreceptor 110i, and transmits the light-receiving signal corresponding to the resulting voltage to the RF signal processing circuit 23. In the same manner, the current-voltage converting circuits 111f, 111g, and 111h respectively convert, to voltages, sums of currents provided by the switching circuits 112f, 112g, and 112h and currents photoelectric-converted by the photoreceptors 110j, 110k, and 110l, and transmit the light-receiving signals corresponding to the resulting voltages to the RF signal processing circuit 23.

More specifically, the current-voltage converting circuits 111e to 111h generate the light-receiving signals E+I, F+J, G+K, and H+L in the one-time mode, and light-receiving signals nE+I, nF+J, nG+K, and nH+L in the N-time mode. Here, the light-receiving signal E+I is a signal corresponding to a sum of intensity of the first sub-beam received by the photoreceptor 110e and intensity of the second sub-beam received by the photoreceptor 110i. Similarly, the light-receiving signals F+J, G+K, and H+L are signals respectively corresponding to sums of intensity of the first sub-beams received by the photoreceptors 110f, 110g, and 110h and intensity of the second sub-beams received by the photoreceptors 110j, 110k, and 110l. Furthermore, the light-receiving signal nE+I is a signal corresponding to a sum of (i) a value obtained by multiplying, by N, the intensity of the first sub-beam received by the photoreceptor 110e and (ii) a value of the intensity of the second sub-beam received by the photoreceptors 110i. Similarly, the light-receiving signals nF+J, nG+K, and nH+L are signals respectively corresponding to sums of (i) values obtained by multiplying, by N, the intensity of the first sub-beams received by the photoreceptors 110f, 110g, and 110h and (ii) values of the intensity of the second sub-beams received by the photoreceptors 110j, 110k, and 110l.

Next, the operations of the photoelectric converting device 100 will be described.

First, the operations of the photoelectric converting device 100 in the one-time mode will be described.

Each of the switches 114 selects the current photoelectric-converted by a corresponding one of the photoreceptors 110e to 110h in the one-time mode.

Thus, a sum of the current photoelectric-converted by the photoreceptor 110e included in the second photoreceptor group 102 and the current photoelectric-converted by the photoreceptor 110i included in the third photoreceptor group 103 is provided to the current-voltage converting circuit 111e. In the same manner, the sums of the currents photoelectric-converted by the photoreceptors 110f, 110g, and 110h included in the second photoreceptor group 102 and the currents photoelectric-converted by the photoreceptors 110j, 110k, and 110l included in the third photoreceptor group 103 are respectively provided to the current-voltage converting circuits 111f, 111g, and 111h. The current-voltage converting circuits 111e to 111h respectively convert input currents corresponding to the respective sums to voltages to generate the light-receiving signals E+I, F+J, G+K, and H+L and transmit the generated light-receiving signals E+I, F+J, G+K, and H+L.

Furthermore, the current signals photoelectric-converted by the photoreceptors 110a to 110d included in the first photoreceptor group 101 are respectively provided to the current-voltage converting circuits 111a to 111d. The current-voltage converting circuits 111a to 111d convert input currents corresponding to the current signals to voltages to generate the light-receiving signals A to D and transmit the generated light-receiving signals A to D.

In such a manner, the photoelectric converting device 100 generates the light-receiving signals A to D respectively corresponding to the intensity of the main beams emitted on the photoreceptors 110a to 110d. Furthermore, the photoelectric converting device 100 generates the light-receiving signal E+I corresponding to a sum of intensity of the first sub-beam received by the photoreceptor 110e and intensity of the second sub-beam received by the photoreceptor 110i. Similarly, the photoelectric converting device 100 generates the light-receiving signals F+J, G+K, and H+L respectively corresponding to sums of intensity of the first sub-beams received by the photoreceptors 110f, 110g, and 110h and intensity of the second sub-beams received by the photoreceptors 110j, 110k, and 110l.

Next, the operations of the photoelectric converting device 100 in the N-time mode will be described.

Each of the switches 114 selects the current multiplied by N by a corresponding one of the current amplifying circuits 113 in the N-time mode. Thus, the switching circuit group 112 multiplies, by N, the currents photoelectric-converted by the photoreceptors 110e to 110h included in the second photoreceptor group 102, and supplies the currents multiplied by N to the current-voltage converting circuits 111e to 111h, respectively.

In other words, the currents obtained by multiplying, by N, the currents photoelectric-converted by the photoreceptors 110e to 110h included in the second photoreceptor group 102 are respectively added to the currents photoelectric-converted by the photoreceptors 110i to 110l included in the third photoreceptor group 103, and the resulting currents are supplied to the current-voltage converting circuits 111e to 111h. The current-voltage converting circuits 111e to 111h convert the input currents to voltages to generate the light-receiving signals nE+I, nF+J, nG+K, and nH+L and transmit the generated light-receiving signals nE+I, nF+J, nG+K, and nH+L.

Furthermore, the current signals photoelectric-converted by the photoreceptors 110a to 110d included in the first photoreceptor group 101 are respectively provided to the current-voltage converting circuits 111a to 111d as in the one-time mode. The current-voltage converting circuits 111a to 111d convert input currents corresponding to the current signals to voltages to generate the light-receiving signals A to D and transmit the generated light-receiving signals A to D.

Next, the operations of the photoelectric converting device 100 in the normal operation will be described.

In the normal operation, the one-time mode is selected under the control of the optical disk controller 22.

Thereby, the photoelectric converting device 100 generates the light-receiving signals A to D according the intensity of the main beams emitted on the photoreceptors 110a to 110d, respectively. Furthermore, the photoelectric converting device 100 generates the light-receiving signal E+I corresponding to a sum of intensity of the first sub-beam received by the photoreceptor 110e and intensity of the second sub-beam received by the photoreceptor 110i. Similarly, the photoelectric converting device 100 generates the light-receiving signals F+J, G+K, and H+L respectively corresponding to sums of intensity of the first sub-beams received by the photoreceptors 110f, 110g, and 110h and intensity of the second sub-beams received by the photoreceptors 110j, 110k, and 110l.

More specifically, the RF signal processing circuit 23 calculates, for example, a focus error signal FE by the differential astigmatism method, and a tracking error signal TE by the differential push-pull method. More specifically, the RF signal processing circuit 23 calculates the focus error signal FE using Equation (1) and the tracking error signal TE using Equation (2). Furthermore, the RF signal processing circuit 23 performs signal processing on the light-receiving signals A to D respectively corresponding to data recorded on the optical disk 50, and transmits the resulting signals outside the optical disk apparatus 10.

Next, the operations for adjusting the spot positions of the main beam, the first sub-beam, and the second sub-beam that are reflected from the optical disk 50 and are emitted on the photoelectric converting device 100 in order to adjust the configuration of the optical system 15 and the position of the photoelectric converting device 100 will be described.

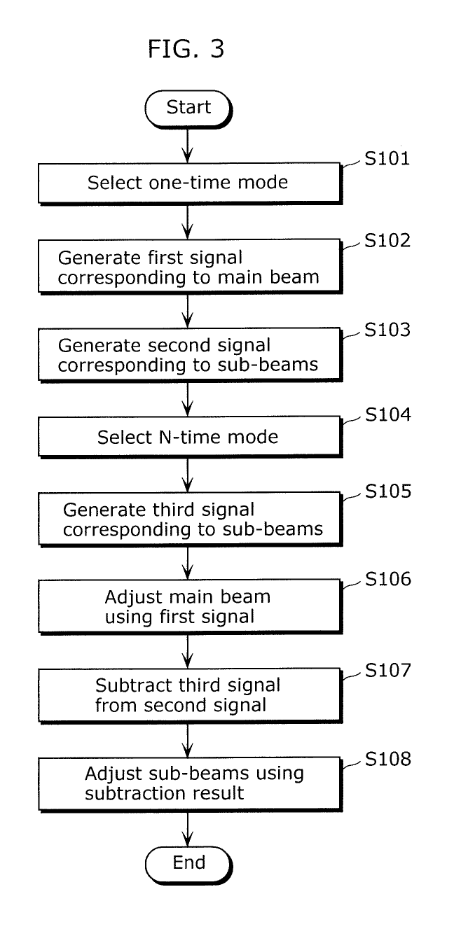

FIG. 3 is a flowchart showing the adjustment operations using the photoelectric converting device 100.

First, the one-time mode is selected under the control of the optical disk controller 22 (S101).

Next, the photoelectric converting device 100 in the one-time mode transmits the first signals (light-receiving signals A to D) respectively corresponding to the main beams to the RF signal processing circuit 23 (S102), and transmits the second signals (light-receiving signals E+I, F+J, G+K, and H+L) respectively corresponding to sums of the first and second sub-beams to the RF signal processing circuit 23 (S103).

Next, the N-time mode is selected under the control of the optical disk controller 22 (S104).

Next, the photoelectric converting device 100 in the N-time mode transmits the first signals (light-receiving signals A to D) respectively corresponding to the main beams to the RF signal processing circuit 23, and transmits the third signals (light-receiving signals nE+I, nF+J, nG+K, and nH+L) respectively corresponding to sums of the second sub-beams and the first sub-beams multiplied by N to the RF signal processing circuit 23 (S105).

Furthermore, the RF signal processing circuit 23 performs signal processing on the first signals (light-receiving signals A to D), and transmits the resulting signals outside the optical disk apparatus 10. Next, a person or a device outside the optical disk apparatus 10 adjusts, using the first signals (light-receiving signals A to D), the spot position of the main beam reflected from the optical disk 50 and emitted on the photoelectric converting device 100 so that the spot position is in the middle of the photoreceptors 110a to 110d (S106). More specifically, the person or the device outside adjusts the configuration of the optical system 15 and the position of the photoelectric converting device 100 to satisfy A=B=C=D.

Furthermore, the RF signal processing circuit 23 respectively subtracts the third signals (light-receiving signals nE+I, nF+J, nG+K, and nH+L) from the second signals (light-receiving signals E+I, F+J, G+K, and H+L) to calculate subtraction signals (light-receiving signals (1−n)E, (1−n)F, (1−n)G, and (1−n)H) (S107). Furthermore, the RF signal processing circuit 23 transmits the calculated subtraction signals (light-receiving signals (1−n)E, (1−n)F, (1−n)G, and (1−n)H) outside the optical disk apparatus 10.

Furthermore, the person or the device outside adjusts, using the calculated subtraction signals (light-receiving signals (1−n)E, (1−n)F, (1−n)G, and (1−n)H), (i) the spot position of the first sub-beam reflected from the optical disk 50 and emitted on the photoelectric converting device 100 so that the spot position is in the middle of the photoreceptors 110e to 110h, and (ii) the spot position of the second sub-beam reflected from the optical disk 50 and emitted on the photoelectric converting device 100 so that the spot position is in the middle of the photoreceptors 110i to 110l (S108). More specifically, the person or the device outside adjusts the configuration of the optical system 15 and the position of the photoelectric converting device 100 to satisfy (1−n)E=(1−n)F=(1−n)G =(1−n)H.

With the aforementioned operations, the middle of the spot position of the main beam matches the middle of the first photoreceptor group 101. Similarly, the middle of the spot positions of the first sub-beam and the second sub-beam respectively matches the middle of the second photoreceptor group 102 and the third photoreceptor group 103.

Here, the light-receiving signals E to H can be expressed by Equations (3) to (6), when the offset voltages occurring in the current-voltage converting circuits 111e to 111h and other circuits in a latter stage are respectively defined as VoffE, VoffF, VoffG, and VoffH, and light-receiving signal components that do not include offset voltages in each of the light-receiving signals E to H are respectively defined as E0, F0, G0, H0.

E=E0+VoffE Equation (3)

F=F0+VoffF Equation (4)

G=G0+Voff1G Equation (5)

H=H0+Voff1H Equation (6)

Here, the offset voltages VoffE to Voff1H vary according to the variations in transistors and capacitors included in each of the current-voltage converting circuits 111e to 111h. Thus, even when the configuration of the optical system 15 and the position of the photoelectric converting device 100 are adjusted to satisfy E=F=G=H, in the case of VoffE≠VoffF, E0≠F0 is derived from the following Equations (7) and (8).

E=F Equation (7)

E0+VoffE=F0+VoffF Equation (8)

Similarly, even when the configuration of the optical system 15 and the position of the photoelectric converting device 100 are adjusted to satisfy E=F=G=H, the equation E0=F0=G0=H0 does not hold except when VoffE to VoffH are all equal. In other words, when the offset voltages VoffE to VoffH vary, the middle of the spot positions of the first and second sub-beams does not respectively match the middle of the second photoreceptor group 102 and the third photoreceptor group 103.

On the other hand, an offset voltage can be cancelled using the photoelectric converting device 100 according to the present invention.

Here, the offset voltages occurring in the current-voltage converting circuits 111e, 111f, 111g, and 111h and other circuits in a latter stage are respectively defined as VoffE, VoffF, VoffG, and VoffH, and light-receiving signal components that do not include the offset voltages in each of the light-receiving signals E+I, F+J, G+K, and H+L in the one-time mode are respectively defined as E0+I0, F0+J0, G0+K0, and H0+L0. In this case, the light-receiving signal components that do not include the offset voltages in the light-receiving signals nE+I, nF+J, nG+K, and nH+L in the N-time mode are respectively defined as nE0+I0, nF0+J0, nG0+K0, and nH0+L0. Thus, the light-receiving signals E+I, F+J, G+K, and H+L in the one-time mode and the light-receiving signals nE+I, nF+J, nG+K, and nH+L in the N-time mode can be expressed by Equations (9) to (16) as follows.

E+I=E0+I0+VoffE Equation (9)

F+J=F0+J0+VoffF Equation (10)

G+K=G0+K0+VoffG Equation (11)

H+L=H0+L0+VoffH Equation (12)

nE+I=nE0+I0+VoffE Equation (13)

nF+J=nF0+J0+VoffF Equation (14)

nG+K=nG0+K0+VoffG Equation (15)

nH+L=nH0+L0+VoffH Equation (16)

Thus, the light-receiving signals (1−n)E, (1−n)F, (1−n)G, and (1−n)H respectively obtained by subtracting the light-receiving signals nE+I, nF+J, nG+K, and nH+L in the N-time mode from the light-receiving signals E+I, F+J, G+K, and H+L in the one-time mode can be expressed by Equations (17) to (20) as follows.

$$\begin{matrix}\begin{matrix}( 1 - n ) E = ( E 0 + I 0 + VoffE ) - ( nE 0 + I 0 + VoffE ) \\ = ( 1 - n ) E 0\end{matrix} & Equation ( 17 ) \\ \begin{matrix}( 1 - n ) F = ( F 0 + J 0 + VoffF ) - ( n F 10 + J 0 + VoffF ) \\ ( 1 - n ) F 0\end{matrix} & Equation ( 18 ) \\ \begin{matrix}( 1 - n ) G = ( G 0 + K 0 + VoffG ) - ( nG 0 + K 0 + Voff G ) \\ = ( 1 - n ) G 0\end{matrix} & Equation ( 19 ) \\ \begin{matrix}( 1 - n ) H = ( H 0 + L 0 + VoffH ) - ( nH 0 + L 0 + VoffH ) \\ = ( 1 - n ) H 0\end{matrix} & Equation ( 20 )\end{matrix}$$

As expressed by Equations (17) to (20), the offset voltages VoffE to VoffH are cancelled.

In this manner, the photoelectric converting device 100 according to the present invention adjusts the configuration of the optical system 15 and the position of the photoelectric converting device 100 to satisfy (1−n)E=(1−n)F=(1−n)G=(1−n)H. As a result, the middle of the spot positions of the first sub-beams and the second sub-beams can respectively matches the middle of the second photoreceptor group 102 and the third photoreceptor group 103. Thus, the optical disk apparatus 10 can generate the focus error signal FE and the tracking control signal TE that are more precise. Furthermore, the assembly yield of the optical disk apparatus 10 can be improved.

Although the photoelectric converting device 100 operates in the N-time mode after the one-time mode in Embodiment 1, the photoelectric converting device 100 may operate in the one-time mode after the N-time mode.

Furthermore, although a person or a device outside the optical disk apparatus 10 adjusts the sub-beams after adjusting the main beam in Embodiment 1, the person or the device may adjust the main beam after adjusting the sub-beams.

Furthermore, the light-receiving signals A to D for use in adjusting the main beam may be signals generated in the one-time mode and in the N-time mode.

Furthermore, although the RF signal processing circuit 23 performs the processing in Step S107 (subtraction processing) in Embodiment 1, a person or a device outside the optical disk apparatus 10 may perform the subtraction processing. In other words, the RF signal processing circuit 23 may transmit the second signal and the third signal outside the optical disk apparatus 10.

Furthermore, the photoelectric converting device 100 may transmit the first to third signals for use in adjusting beams directly outside the optical disk apparatus 10 without through the RF signal processing circuit 23.

Furthermore, although the person or the device outside adjusts the main beam (S106) and the sub-beams (S108) in Embodiment 1, a processing unit (not illustrated) included in the optical disk apparatus 10 may automatically adjust those beams.

Furthermore, signals to be transmitted outside by the optical disk apparatus 10 may be signals obtained by performing predetermined processing on the subtraction signals (light-receiving signals (1−n)E, (1−n)F, (1−n)G, and (1−n)H), not limited to the subtraction signals. In other words, the signals to be transmitted outside by the optical disk apparatus 10 have only to be signals including a signal representing a matching degree between the middle of the spot position of the first sub-beam and the middle of the second photoreceptor group 102, and a signal representing a matching degree between the middle of the spot position of the second sub-beam and the middle of and the third photoreceptor 103.

The following will describe a specific example of the current amplifying circuit 113.

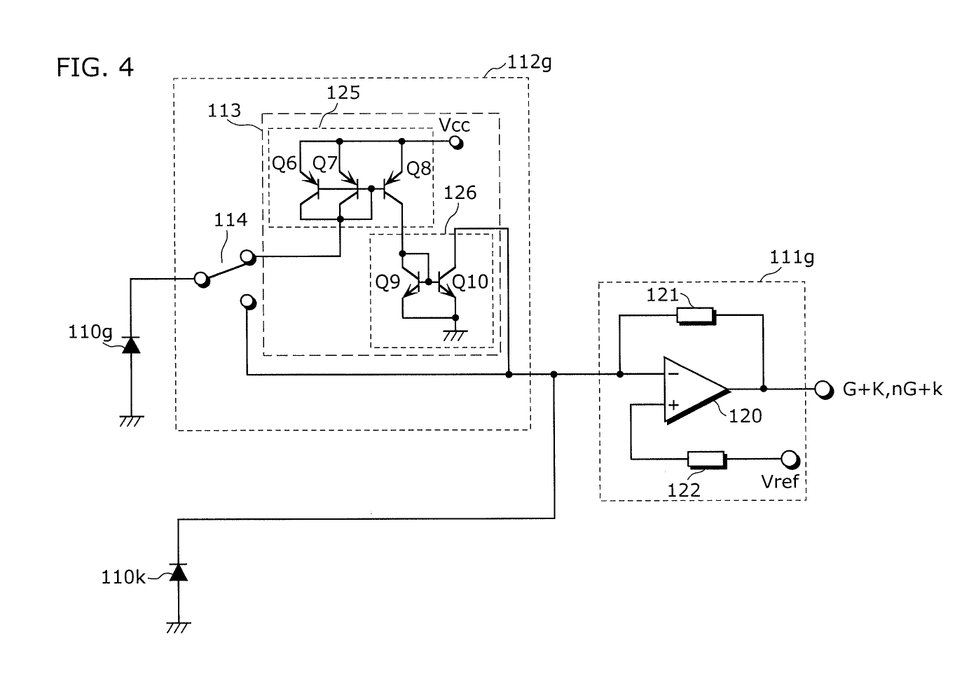

FIG. 4 illustrates a circuit configuration of a switching circuit 112g and a current-voltage converting circuit 111g. Here, the configuration of the switching circuit 112g is the same as those of the switching circuits 112e, 112f, and 112h, and the configuration of the current-voltage converting circuit 111g is the same as those of the current-voltage converting circuits 111e, 111f, and 111h. Thus, the description of the respective configurations of the switching circuit 112g and the current-voltage converting circuit 111g is omitted hereinafter.

The current amplifying circuit 113 in FIG. 4 includes a current mirror circuit 125 including transistors Q6 to Q8, and a current mirror circuit 126 including transistors Q9 and Q10.

The current mirror circuit 125 multiplies, by N, a photoelectric current generated by the photoreceptor 110g, shifts (inverts) a phase of the photoelectric current by 180 degrees, and supplies the resulting photoelectric current to the current mirror circuit 126.

The current mirror circuit 126 inverts the phase of the photoelectric current supplied by the current mirror circuit 125, and supplies the inverted photoelectric current. In other words, the current mirror circuit 126 matches phases of the photoelectric current generated by a photoreceptor 110k and the current supplied by the current amplifying circuit 113 by restoring the phase shifted by the current mirror circuit 125 to the initial position.

Here, Vcc is a power supply voltage to be applied to the current-voltage converting circuit 111g and the current amplifying circuit 113.

Since the current mirror circuit 125 has a current mirror ratio of 1 to 2, half the photoelectric current generated by the photoreceptor 110g is supplied to the current-voltage converting circuit 111g. In other words, the current-voltage converting circuit 111g generates a light-receiving signal G/2+K in the N-time mode.

Furthermore, as illustrated in FIG. 4, the current-voltage converting circuit 111g includes a differential amplifier 120, a gain resistor 121, and a resistor 122.

The differential amplifier 120 is an operational amplifier including an inverting input terminal, a non-inverting input terminal, and an output terminal.

The gain resistor 121 is a feedback resistor to be connected between the inverting input terminal and the output terminal of the differential amplifier 120.

The resistor 122 is connected between the non-inverting input terminal of the differential amplifier 120 and a reference voltage Vref. The resistor 122 suppresses occurrence of an offset voltage by adjusting an input impedance of the current-voltage converting circuit 111g.

Here, since a gain N of the current amplifying circuit 113 is a value to be optionally selected according to the design of the optical pickup device, a current mirror ratio of the current mirror circuit 125 may be determined according to the design.

The following will describe a variation of the current amplifying circuit 113.

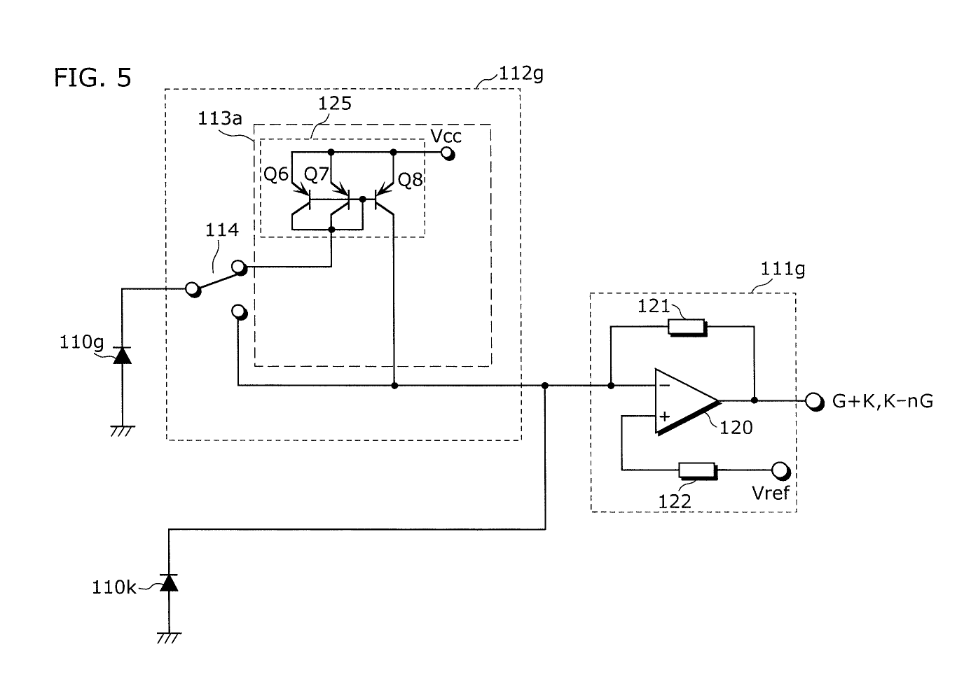

FIG. 5 illustrates a circuit configuration of a current amplifying circuit 113a that is a variation of the current amplifying circuit 113.

The current amplifying circuit 113a in FIG. 5 excludes the current mirror circuit 126 in FIG. 4 and only includes the current mirror circuit 125. With such a configuration, the current amplifying circuit 113a generates a current having a phase shifted by 180 degrees with respect to a phase of the photoelectric current generated by the photoreceptor 110k. In other words, the current-voltage converting circuit 111g receives a current obtained by subtracting, from the photoelectric current generated by the photoreceptor 110k, a current obtained by multiplying, by N, the current generated by the photoreceptor 110g. Thereby, the current-voltage converting circuit 111g generates a light-receiving signal K−nG in the N-time mode. Even in this case, the current-voltage converting circuit 111g can generate a signal in which an offset voltage is cancelled, by subtracting the light-receiving signal K−nG in the N-time mode from the light-receiving signal G+K in the one-time mode as in the aforementioned processing.

As such, the configuration of the current amplifying circuit 113 can be easily changed according to a specification of a circuit in which a light-receiving signal generated by the current-voltage converting circuit 111g is processed (the RF signal processing circuit 23 in this example). Thereby, the design flexibility of the photoelectric converting device 100 can be improved.

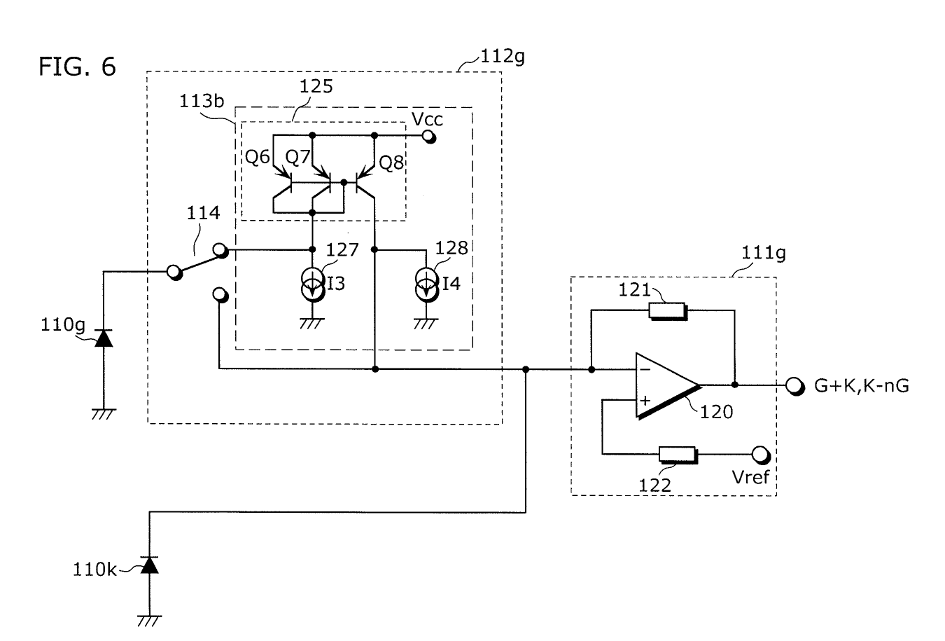

FIG. 6 illustrates a circuit drawing of a configuration of a current amplifying circuit 113b that is another variation of the current amplifying circuit 113.

The current amplifying circuit 113b in FIG. 6 can respond faster than the current amplifying circuit 113a in FIG. 5 by applying an idling current to the current mirror circuit 125.

The current amplifying circuit 113b in FIG. 6 additionally includes current sources 127 and 128 to the configuration of the current amplifying circuit 113a in FIG. 5.

The current source 127 is connected to an input terminal of the current mirror circuit 125, and supplies the idling current to the current mirror circuit 125. The idling current is a current flowing in a direction identical to a direction of the photoelectric current converted by the photoreceptor 110g.

The current source 128 is connected to an output terminal of the current mirror circuit 125. Furthermore, the current source 128 flows in a direction opposite to a direction of the current supplied by the current mirror circuit 125, and supplies a current obtained by multiplying, by N, the idling current supplied from the current source 127. In other words, the current source 128 is a circuit for canceling the idling current supplied from the current source 127.

In the case of a current amplifying circuit including only the current source 127, since the idling current supplied to the current mirror circuit 125 flows in the current-voltage converting circuit 111g, the offset voltage occurs in the current-voltage converting circuit 111g. For this problem, the current amplifying circuit 113b can suppress occurrence of the offset voltage with the current source 128.

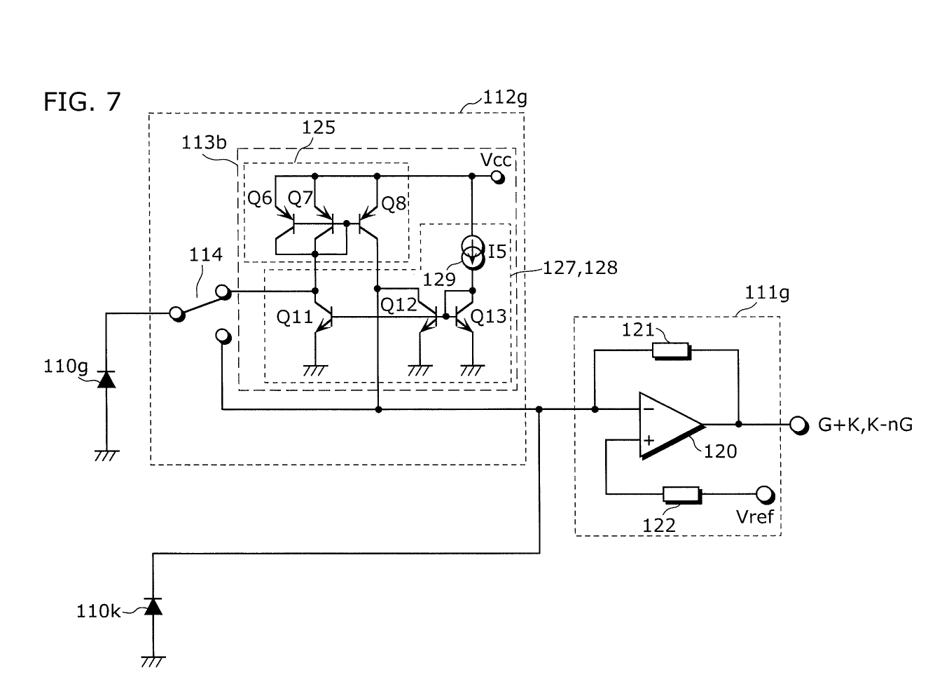

FIG. 7 illustrates a specific example of the current sources 127 and 128 in FIG. 6.

The current sources 127 and 128 include transistors Q11 to Q13, and a current source 129 as illustrated in FIG. 7. More specifically, a combination of the transistors Q11 and Q13 and the current source 129 corresponds to the current source 127, and a combination of the transistors Q12 and Q13 and the current source 129 corresponds to the current source 128. In other words, the transistor Q13 and the current source 129 are shared between the current sources 127 and 128.

The current source 129 supplies a current equivalent to the idling current.

The transistors Q11 and Q13 form a current mirror circuit. The current mirror circuit supplies an idling current to the input terminal of the current mirror circuit 125 by mirroring the current supplied from the current source 129.

The transistors Q12 and Q13 also form a current mirror circuit. The current mirror circuit pulls a current equivalent to the idling current supplied from the output terminal of the current mirror circuit 125 by mirroring the current supplied from the current source 129.

Such a configuration of the current sources 127 and 128 can cancel an idling current.

Furthermore, since the current mirror ratio of the current mirror circuit 125 is 2, the idling current can be cancelled with an emitter area of the transistor Q11 twice as large as an emitter area of the transistor Q12.

### Embodiment 2

Embodiment 2 describes a photoelectric converting device 200 that is an application of the photoelectric converting device 100 according to Embodiment 1, and that supports laser light for DVDs and CDs.

Furthermore, the configuration of the optical disk apparatus 10 including the photoelectric converting device 200 is the same as that of FIG. 1, and thus the description is omitted hereinafter. The LD 11 in FIG. 1 selectively emits laser light for DVDs (red laser light), and laser light for CDs (infrared laser light). Furthermore, the laser light for DVDs and CDs is emitted on the optical disk 50 (DVD or CD) through the optical system 15, is reflected from the optical disk 50, and is emitted on the photoelectric converting device 200 through the optical system 15.

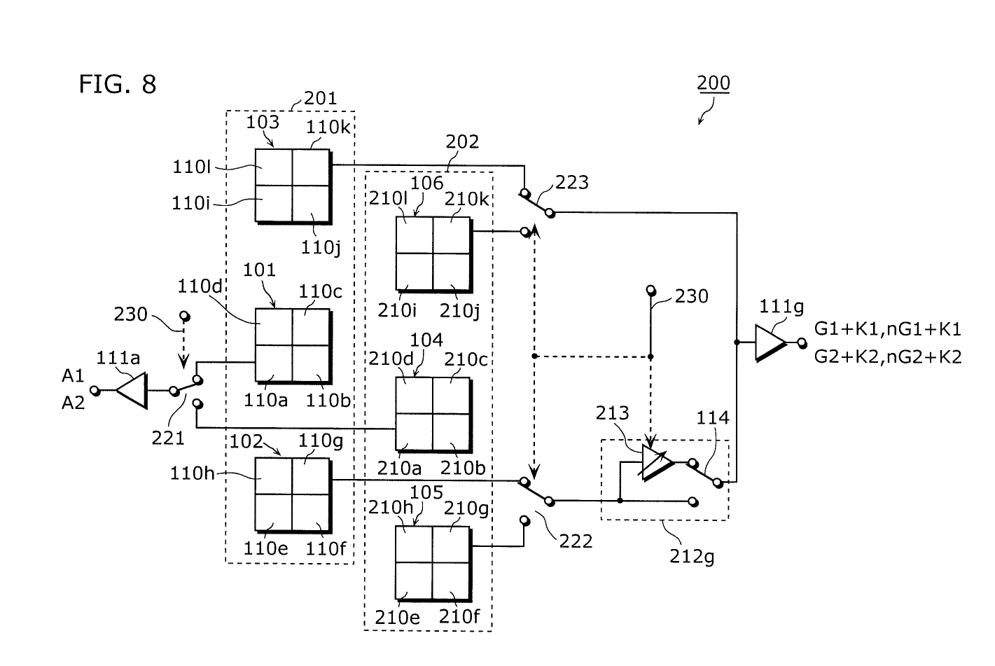

FIG. 8 illustrates a configuration of the photoelectric converting device 200 according to Embodiment 2 of the present invention. Here, the same numerals are attached to the elements as in FIG. 2. Furthermore, FIG. 8 illustrates a circuit configuration of only 1 photoreceptor out of 4 photoreceptors included in each of photoreceptor group 101 to 106 to simplify the description. Actually, each of the 4 photoreceptors has the same circuit configuration as in FIG. 8.

The photoelectric converting device 200 in FIG. 8 has the one-time mode and the N-time mode as the photoelectric converting device 100 according to Embodiment 1. Furthermore, the photoelectric converting device 200 has a CD mode to be selected when data recorded on a CD is read or data is written on a CD, and a DVD mode to be selected when data recorded on a DVD is read or data is written on a DVD. The optical disk controller 22 switches between the CD and DVD modes.

Furthermore, the photoelectric converting device 200 includes a CD photoreceptor group 201 that receives laser light for CDs, a DVD photoreceptor group 202 that receives laser light for DVDs, current-voltage converting circuits 111a and 111g, switches 221 to 223, and a switching circuit 212g.

The CD photoreceptor group 201 includes a first photoreceptor group 101, a second photoreceptor group 102, and a third photoreceptor group 103. The DVD photoreceptor group 202 includes a first photoreceptor group 104, a second photoreceptor group 105, and a third photoreceptor group 106.

Furthermore, the CD photoreceptor group 201 is spaced apart from the DVD photoreceptor group 202 by a distance approximately equivalent to a distance to an emission point of laser light.

The first photoreceptor group 101 includes 4 photoreceptors 110a to 110d, and receives a main beam that is reflected from the optical disk 50 and that is for CDs. The second photoreceptor group 102 includes 4 photoreceptors 110e to 110h, and receives a first sub-beam that is reflected from the optical disk 50 and that is for CDs. The third photoreceptor group 103 includes 4 photoreceptors 110i to 110l, and receives a second sub-beam that is reflected from the optical disk 50 and that is for CDs.

The first photoreceptor group 104 includes 4 photoreceptors 210a to 210d, and receives a main beam that is reflected from the optical disk 50 and that is for DVDs. The second photoreceptor group 105 includes 4 photoreceptors 210e to 210h, and receives a first sub-beam that is reflected from the optical disk 50 and that is for DVDs. The third photoreceptor group 106 includes 4 photoreceptors 210i to 210l, and receives a second sub-beam that is reflected from the optical disk 50 and that is for DVDs.

Furthermore, each of the photoreceptors 110a to 110l receives laser light having a wavelength for CDs, and performs photoelectric conversion on the received laser light to convert the received laser light to a current. Furthermore, each of the photoreceptors 210a to 210l receives laser light having a wavelength for DVDs, and performs photoelectric conversion on the received laser light to convert the received laser light to a current.

The switch 221 selects the current generated by one of the photoreceptors 110a and 210a, and supplies the selected current to the current-voltage converting circuit 111a.

The switch 222 selects the current generated by one of the photoreceptors 110g and 210g, and supplies the selected current to the switching circuit 212g.

The switch 223 selects the current generated by one of the photoreceptors 110k and 210k, and supplies the selected current to the current-voltage converting circuit 111g.

More specifically, in the CD mode, the switches 221, 222, and 223 respectively select the currents generated by the photoreceptors 110a, 110g, and 110k, while in the DVD mode, the switches 221, 222, and 223 respectively select the currents generated by the photoreceptors 210a, 210g, and 210k. Furthermore, the switches 221, 222, and 223 are controlled by a mode selection signal 230 provided from the optical disk controller 22.

The current-voltage converting circuit 111a converts an input current to a voltage to generate one of light-receiving signals A1 and A2, and transmits one of the generated light-receiving signals A1 and A2. Here, the light-receiving signal A1 is a signal corresponding to intensity of the main beam that is received by the photoreceptor 110a and that is for CDs, and the light-receiving signal A2 is a signal corresponding to intensity of the main beam that is received by the photoreceptor 210a and that is for DVDs.

The switching circuit 212g includes a current amplifying circuit 213 and a switch 114.

The current amplifying circuit 213 multiplies, by N, the current supplied from the switch 222 (current photoelectric-converted by one of the photoreceptors 110g and 210g). Here, N is typically a figure less than 1 and larger than 0. In other words, the current amplifying circuit 213 attenuates the current supplied from the switch 222.

The switch 114 selects one of the current multiplied by N by the current amplifying circuit 213 and the current supplied from the switch 222, and supplies the selected current to the current-voltage converting circuit 111g. More specifically, the switch 114 selects one of the current supplied from the switch 222 in the one-time mode (first operating mode), and the current multiplied by N by the current amplifying circuit 213 in the N-time mode (second operating mode).

The current-voltage converting circuit 111g generates one of light-receiving signals G1+K1, nG1+K1, G2+K2, and nG2+K2 each obtained by converting a sum of currents provided to the switch 223 and the switching circuit 212g to a voltage. Here, the light-receiving signal G1+K1 is a signal corresponding to a sum of intensity of the beams received by the photoreceptors 110g and 110k, and the light-receiving signal nG1+K1 is a signal corresponding to a sum of intensity obtained by multiplying, by N, the beam received by the photoreceptor 110g and the intensity of the beam received by the photoreceptor 110k. Furthermore, the light-receiving signal G2+K2 is a signal corresponding to a sum of intensity of the beams received by the photoreceptors 210g and 210k, and the light-receiving signal nG2+K2 is a signal corresponding to a sum of intensity obtained by multiplying, by N, the beam received by the photoreceptor 210g and the intensity of the beam received by the photoreceptor 210k.

With such a configuration, in the CD mode and the one-time mode, the photoelectric converting device 200 generates the light-receiving signal A1 corresponding to the main beam received by the photoreceptor 110a, and the light-receiving signal G1+K1 corresponding to a sum of intensity of the sub-beams received by the photoreceptors 110g and 110k. Furthermore, in the CD mode and the N-time mode, the photoelectric converting device 200 generates the light-receiving signal nG1+K1 corresponding to a sum of intensity obtained by multiplying, by N, the first sub-beam received by the photoreceptor 110g and intensity of the second sub-beam received by the photoreceptor 110k.

Thereby, the configuration of the optical system 15 and the position of the photoelectric converting device 200 can be adjusted with higher precision with use of a signal obtained by subtracting the light-receiving signal nG1+K1 from the light-receiving signal G1+K1 as in the photoelectric converting device 100 according to Embodiment 1.

Furthermore, in the DVD mode and the one-time mode, the photoelectric converting device 200 generates the light-receiving signal A2 corresponding to the main beam received by the photoreceptor 210a and the light-receiving signal G2+K2 corresponding to a sum of intensity of the sub-beams received by the photoreceptors 210g and 210k. Furthermore, in the DVD mode and the N-time mode, the photoelectric converting device 200 generates the light-receiving signal nG2+K2 signal corresponding to a sum of intensity obtained by multiplying, by N, the first sub-beam received by the photoreceptor 210g and intensity of the second sub-beam received by the photoreceptor 210k.

Thereby, the configuration of the optical system 15 and the position of the photoelectric converting device 200 in the DVD mode can be adjusted with higher precision with use of a signal obtained by subtracting the light-receiving signal nG2+K2 from the light-receiving signal G2+K2 as in the photoelectric converting device 100 according to Embodiment 1.

Thus, a device outside the optical disk apparatus 10 can adjust a positional relationship in the configuration of the optical system 15 in the CD mode and the DVD mode with higher precision using the photoelectric converting device 200 according to Embodiment 2.

The following will describe a specific example of the current amplifying circuit 213.

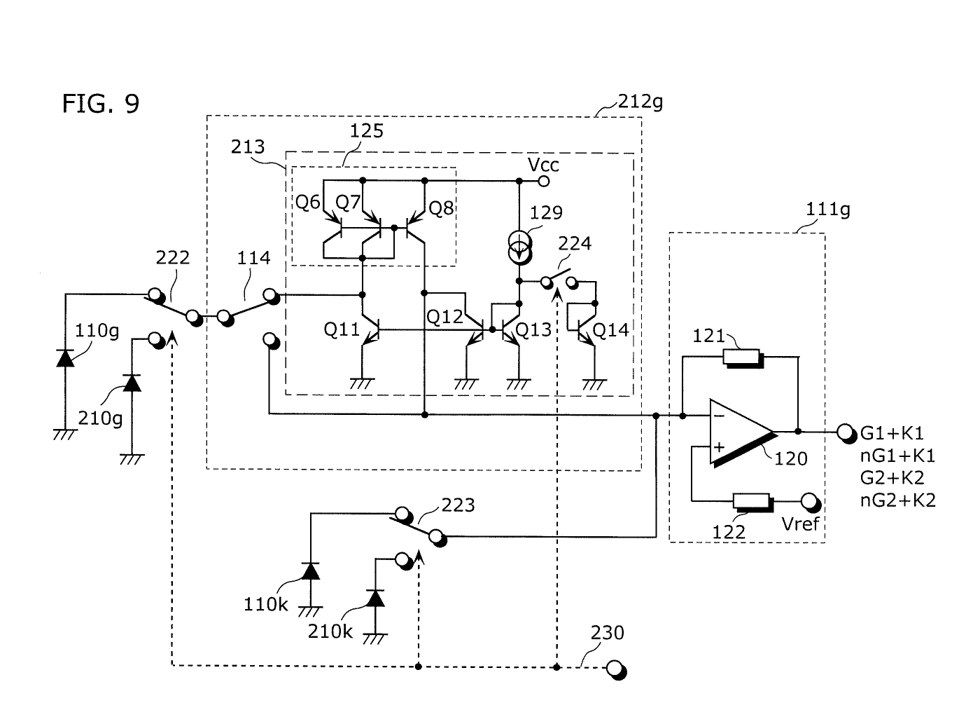

FIG. 9 illustrates a configuration of the current amplifying circuit 213. The current amplifying circuit 213 in FIG. 9 has an advantage of canceling an offset voltage by supplying an idling current as the current amplifying circuit 113b in FIG. 7. Furthermore, the current amplifying circuit 213 supplies different idling currents in the CD mode and the DVD mode, to the current mirror circuit 125.

This is because the reproduction speed in the CD mode is slower than that of the DVD mode, which allows the frequency characteristic to be kept lower and the idling current to be relatively smaller in the DVD mode.

The current amplifying circuit 213 additionally includes a switch 224 and a transistor Q14 to the configuration of the current amplifying circuit 113b.

The switch 224 is controlled by the mode selection signal 230, and thus, is turned on in the CD mode and is turned off in the DVD mode.

The transistor Q14 is connected to the current source 129 via the switch 224.

With the aforementioned configuration, the idling current equivalent to a current supplied by the current source 129 is supplied to the current mirror circuit 125 in the DVD mode. Furthermore, a part of the current supplied from the current source 129 flows to GND through the transistor Q14 in the CD mode. Thus, the idling current smaller than the idling current in the DVD mode is supplied to the current mirror circuit 125.

Thus, the idling current in the CD mode is made smaller than that of the DVD mode so that an offset voltage and noise that occur in the current mirror circuit 125 and that occur due to the variations in the transistors Q11 to Q13 can be reduced. Thereby, the precision of determining a position can be higher in the CD mode.

Next, a variation of the current-voltage converting circuit 111g will be described.

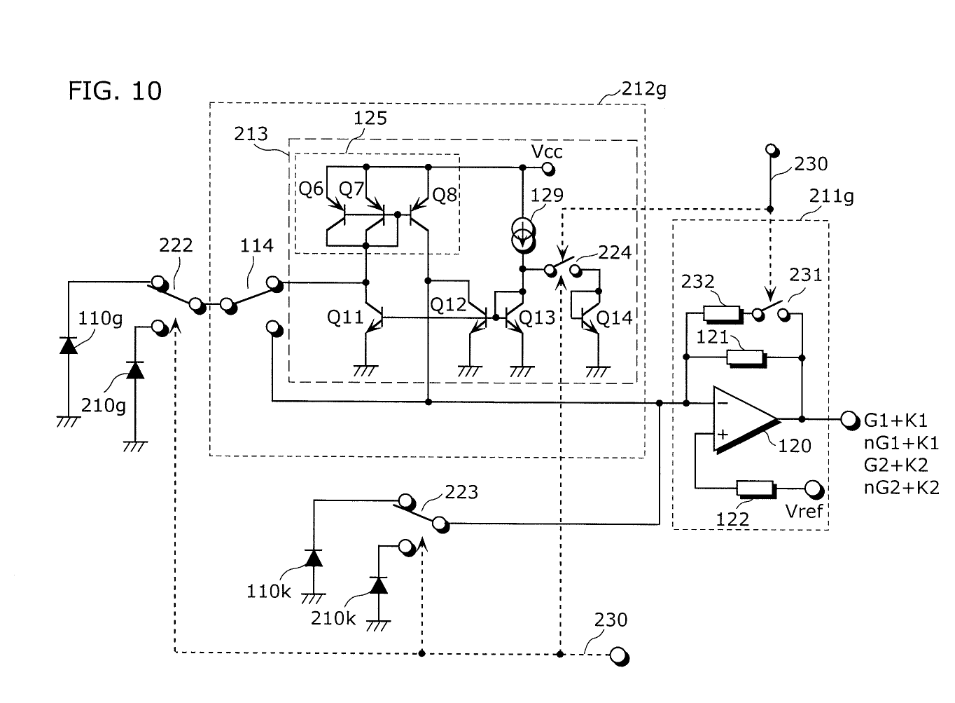

FIG. 10 illustrates a circuit configuration of a current-voltage converting circuit 211g that is the variation of the current-voltage converting circuit 111g.

The current-voltage converting circuit 211g in FIG. 10 uses different current-voltage conversion gains in the CD mode and the DVD mode. The current-voltage converting circuit 211g additionally includes a gain resistor 232 and a switch 231 to the configuration of the current-voltage converting circuit 111g.

The gain resistor 232 and the switch 231 are connected in series. Furthermore, the gain resistor 232 and the switch 231 that are connected in series are connected in parallel with the gain resistor 121 between the non-inverting input terminal and the output terminal of the differential amplifier 120.

Furthermore, the switch 231 is controlled by the mode selection signal 230. More specifically, the switch 231 is turned off in the CD mode and is turned on in the DVD mode.

With the aforementioned configuration, when the switch 231 is turned off, a current-voltage conversion gain of the current-voltage converting circuit 211g is determined according to a resistance value of the gain resistor 121. Furthermore, when the switch 231 is turned on, a current-voltage conversion gain of the current-voltage converting circuit 211g is determined according to a parallel sum of a resistance value of the gain resistor 121 and a resistance value of the gain resistor 232. In other words, a current-voltage conversion gain to be in the CD mode is higher than that of the DVD mode.

Here, when the photoelectric converting device 200 supports various types of optical disk media, generally, the optical disk media have different reflectances, and thus the intensity of beams emitted from the optical disk media to the photoelectric converting device 200 fluctuates. For the fluctuations, the current-voltage converting circuit 211g can adjust a current-voltage conversion gain by controlling a value of a gain resistor.

However, a part of the idling current is supplied to the current-voltage converting circuit 211g due to the variation present between the transistors Q11 and Q13 to no small extent. Thus, a problem that an offset voltage obtained by multiplying a part of the idling current by a gain resistor fluctuates by switching between on and off of the gain resistor arises. For this problem, as described above, the idling current is reduced by turning on the switch 224 in the CD mode according to the present invention. Thereby, the fluctuations of the offset voltage occurring in the current-voltage converting circuit 211g by switching between on and off of the gain resistor can be suppressed. In other words, in the photoelectric converting device 200 according to the present invention, when a current-voltage conversion gain is increased in the current-voltage converting circuit 211g, a difference between the fluctuations of an offset voltage can be offset by reducing the idling current supplied to the current amplifying circuit 213.

### Embodiment 3

Embodiment 3 describes a variation of the current amplifying circuit 113 included in the photoelectric converting device 100 according to Embodiment 1.

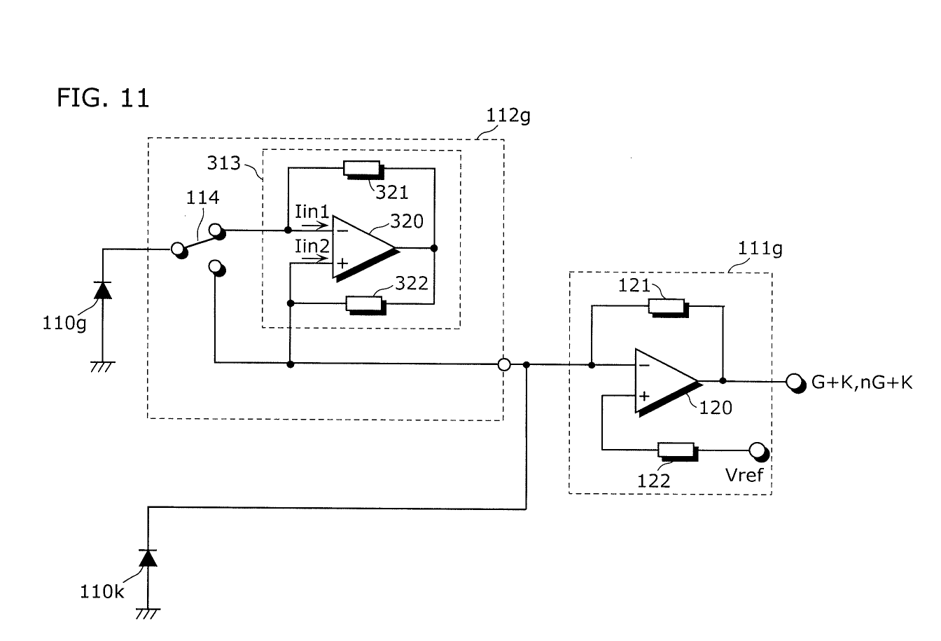

FIG. 11 illustrates a circuit configuration of a current amplifying circuit 313 according to Embodiment 3.

Here, the current amplifying circuit 313 in FIG. 11 is a circuit corresponding to the current amplifying circuit 113 in FIG. 2.

The current amplifying circuit 313 in FIG. 11 includes a differential amplifier 320, and resistors 321 and 322.

The differential amplifier 320 is an operational amplifier including an inverting input terminal, a non-inverting input terminal, and an output terminal. Furthermore, the non-inverting input terminal of the differential amplifier 320 receives a photoelectric current generated by the photoreceptor 110g through the switch 114.

The resistor 321 is connected between the inverting input terminal and the output terminal of the differential amplifier 320. The resistor 322 is connected between the non-inverting input terminal and the output terminal of the differential amplifier 320.

With the configuration, the photoelectric current generated by the photoreceptor 110g is multiplied by N, and is supplied to the non-inverting input terminal of the differential amplifier 320.

Here, a gain N of the current amplifying circuit 313 is determined by a formula (a resistance value of the resistor 321)/(a resistance value of the resistor 322). Thus, the gain N of the current amplifying circuit 313 can be easily not less than 1. Thereby, the design flexibility of the optical pickup device can be improved.

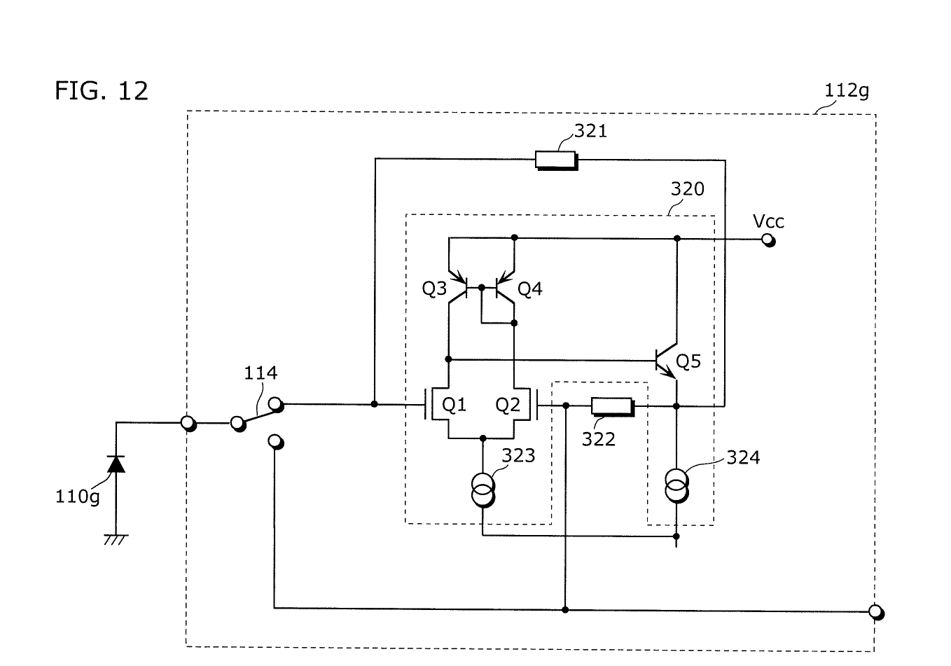

FIG. 12 illustrates a specific example of the current amplifying circuit 313 in FIG. 11.

As illustrated in FIG. 12, the differential amplifier 320 includes transistors Q1 to Q5, and current sources 323 and 324.

A gate of the transistor Q1 is connected to the inverting input terminal of the differential amplifier 320, a gate of the transistor Q2 is connected to the non-inverting input terminal of the differential amplifier 320, and an emitter of the transistor Q5 is connected to the output terminal of the differential amplifier 320. Furthermore, the differential amplifier 320 includes a differential amplifying unit including the transistors Q1 and Q2, an active load that includes the transistors Q3 and Q4 and that is to be a load for the differential amplifying unit, and the transistor Q5 that operates as an emitter follower that buffers an output from the differential amplifying unit.

Furthermore, the transistors Q1 and Q2 are MOS transistors.

Here, when the transistors Q1 and Q2 are bipolar transistors, the base currents (Iin1 and Iin2 in FIG. 11) flow to the current-voltage converting circuit 11g. With this current flow, the offset voltage occurs in the current-voltage converting circuit 111g. Thus, since the MOS transistors in each of which a gate current does not flow are used in replacement of the transistors Q1 and Q2, the precision for an optical pickup device to determine a position can be higher.

The optical disk apparatus 10, and the photoelectric converting devices 100 and 200 according to Embodiments 1 to 3 are described hereinbefore. However, the present invention is not limited to these Embodiments.

For example, although the optical disk apparatus 10 reads data recorded on the optical disk 50 and writes data on the optical disk 50 in Embodiments 1 to 3, the optical disk apparatus 10 may perform at least one operation of reading data recorded on the optical disk 50 and writing data on the optical disk 50.

Furthermore, although the transistors in Embodiments 1 to 3 are mainly bipolar transistors, a part of the transistors or all transistors may be MOS transistors.

The optical disk apparatus 10, the photoelectric converting devices 100 and 200, and each processing unit included in a device that performs a part of the processing in FIG. 3 and that is located outside the optical disk apparatus 10 according to Embodiments 1 to 3 are typically achieved in the form of an integrated circuit or a Large Scale Integrated (LSI) circuit. Each unit of the constituent elements included in these respective apparatus, devices and units may be made as separate individual chips, or a single chip to include a part or all thereof.

Furthermore, the means for circuit integration is not limited to an LSI, and implementation with a dedicated circuit or a general-purpose processor is also available. In addition, it is also acceptable to use a Field Programmable Gate Array (FPGA) that is programmable after the LSI has been manufactured, and a reconfigurable processor in which connections and settings of circuit cells within the LSI are reconfigurable.

A part of or all of the functions of the optical disk apparatus 10, the photoelectric converting devices 100 and 200, and each processing unit included in a device that performs a part of the processing in FIG. 3 and that is located outside the optical disk apparatus 10 according to Embodiments 1 to 3 are achieved with execution of a program by a processor, such as a CPU.

Furthermore, the present invention may also be realized as the program or a computer readable recording medium on which the program is recorded. Furthermore, it is obvious that the present invention may also be realized by the transmission of the aforementioned computer program via a network, such as the Internet.

The optical disk apparatus 10, the photoelectric converting devices 100 and 200, and at least a part of the configurations or the functions of the variations of these devices and apparatus according to Embodiments 1 to 3 may be combined.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention can be applied to a photoelectric converting device, and in particular to an optical disk apparatus that supports various recording media, such as CD-R, CD±RW, DVD-R, DVD±RW, DVD-RAM, and Blu-ray.

What is claimed is:

1. A photoelectric converting device that receives a first main beam, a first sub-beam, and a second sub-beam that are emitted from a light source and reflected from an optical disk, said photoelectric converting device comprising:
first photoreceptors each of which receives the reflected first main beam, and converts the received first main beam to a current;
second photoreceptors each of which receives the reflected first sub-beam, and converts the received first sub-beam to a current;
third photoreceptors each of which receives the reflected second sub-beam, and converts the received second sub-beam to a current;
first current-voltage converting circuits which respectively correspond to said first photoreceptors, and each of which converts the current converted by a corresponding one of said first photoreceptors to a voltage, and supplies the resulting voltage outside said photoelectric converting device;
current amplifying circuits which respectively correspond to said second photoreceptors, and each of which amplifies or attenuates the current converted by a corresponding one of said second photoreceptors;
switching circuits which respectively correspond to said second photoreceptors and said current amplifying circuits, and each of which supplies one of (i) the current converted by the corresponding one of said second photoreceptors and (ii) the current amplified or attenuated by a corresponding one of said current amplifying circuits; and
second current-voltage converting circuits which respectively correspond to said third photoreceptors and said switching circuits, and each of which converts a sum of (i) the current supplied by a corresponding one of said switching circuits and (ii) the current converted by a corresponding one of said third photoreceptors to a voltage, and supplies the resulting voltage outside said photoelectric converting device.

2. The photoelectric converting device according to claim 1,
wherein each of said current amplifying circuits includes
a current mirror circuit which multiplies, by N, the current converted by the corresponding one of said second photoreceptors, inverts a phase of the current multiplied by N, and supplies the inverted current, where N is larger than 0, and
each of said switching circuits supplies one of (i) the current converted by the corresponding one of said second photoreceptors and (ii) the current supplied by a corresponding one of said current mirror circuits.

3. The photoelectric converting device according to claim 2,
wherein each of said current amplifying circuits further includes
a first current source which is connected to an input terminal of a corresponding one of said current mirror circuits, and which supplies a current that flows in a direction identical to a direction of the current converted by a corresponding one of said second photoreceptors.

4. The photoelectric converting device according to claim 3,
wherein each of said current amplifying circuits further includes
a second current source which is connected to an output terminal of a corresponding one of said current mirror circuits, and which supplies a current that flows in a direction opposite to a direction of the current that is supplied by the corresponding one of said current mirror circuits and that is a current obtained by multiplying, by N, the current supplied by a corresponding one of said first current sources.

5. The photoelectric converting device according to claim 3,
wherein the light source emits, to the optical disk, (i) the first main beam, the first sub-beam, and the second sub-beam each having a first wavelength, and (ii) a second main beam, a third sub-beam, and a fourth sub-beam each having a second wavelength different from the first wavelength,
said photoelectric converting device has a first operating mode and a second operating mode,
said photoelectric converting device further comprises:
fourth photoreceptors each of which receives the second main beam that is emitted from the light source and is reflected from the optical disk, and converts the received second main beam to a current;
fifth photoreceptors each of which receives the third sub-beam that is emitted from the light source and is reflected from the optical disk, and converts the received third sub-beam to a current;
sixth photoreceptors each of which receives the fourth sub-beam that is emitted from the light source and is reflected from the optical disk, and converts the received fourth sub-beam to a current;
first switches which respectively correspond to said first photoreceptors and said fourth photoreceptors, and each of which supplies the current converted by the corresponding one of said first photoreceptors in the first operating mode, and supplies the current converted by a corresponding one of said fourth photoreceptors in the second operating mode;
second switches which respectively correspond to said second photoreceptors and said fifth photoreceptors, and each of which supplies the current converted by the corresponding one of said second photoreceptors in the first operating mode, and supplies the current converted by a corresponding one of said fifth photoreceptors in the second operating mode; and
third switches which respectively correspond to said third photoreceptors and said sixth photoreceptors, and each of which supplies the current converted by the corresponding one of said third photoreceptors in the first operating mode, and supplies the current converted by a corresponding one of said sixth photoreceptors in the second operating mode,
each of said first current-voltage converting circuits converts the current supplied by a corresponding one of said first switches to a voltage, and supplies the resulting voltage outside said photoelectric converting device,
each of said current amplifying circuits amplifies or attenuates the current supplied by a corresponding one of said second switches,
each of said switching circuits supplies one of (i) the current supplied by the corresponding one of said second switches and (ii) the current amplified or attenuated by the corresponding one of said current amplifying circuits,
each of said second current-voltage converting circuits converts a sum of (i) the current supplied by the corresponding one of said switching circuits and (ii) the current supplied by a corresponding one of said third switches to a voltage, and supplies the resulting voltage outside said photoelectric converting device, and
each of said first current sources supplies a current having a first current value in the first operating mode, and a current having a second current value in the second operating mode, the second current value being larger than the first current value.

6. The photoelectric converting device according to claim 5,
wherein each of said second current-voltage converting circuits converts a sum of (i) the current supplied by the corresponding one of said switching circuits and (ii) the current supplied by the corresponding one of said third switches to a voltage according to a first current-voltage conversion gain in the first operating mode, and converts a sum of (i) the current supplied by the corresponding one of said switching circuits and (ii) the current supplied by the corresponding one of said third switches to a voltage according to a second current-voltage conversion gain in the second operating mode, the second current-voltage conversion gain being smaller than the first current-voltage conversion gain.

7. The photoelectric converting device according to claim 1,
wherein each of said current amplifying circuits includes:
a first current mirror circuit which amplifies or attenuates the current converted by the corresponding one of said second photoreceptors, and inverts a phase of the resulting current, and supplies the inverted current; and
a second current mirror circuit which inverts the phase of the current supplied by said first current mirror circuit, and supplies the inverted current, and
each of said switching circuits supplies one of (i) the current converted by a corresponding one of said second photoreceptors and (ii) the current supplied by a corresponding one of said second current mirror circuits.

8. The photoelectric converting device according to claim 1
wherein each of said current amplifying circuits includes:
a differential amplifier including an inverting input terminal, a non-inverting input terminal, and an output terminal;
a first resistor which is connected between said inverting input terminal and said output terminal of said differential amplifier; and
a second resistor which is connected between said non-inverting input terminal and said output terminal of said differential amplifier,
each of said inverting input terminals of said differential amplifiers receives the current converted by the corresponding one of said second photoreceptors, and
each of said current amplifying circuits supplies the amplified or attenuated current to a corresponding one of said non-inverting input terminals of said differential amplifiers.

9. The photoelectric converting device according to claim 8,
wherein each of said differential amplifiers further includes:
a first MOS transistor connected to a gate of a corresponding one of said inverting input terminals of said differential amplifiers; and
a second MOS transistor connected to a gate of the corresponding one of said non-inverting input terminals of said differential amplifiers.

10. An optical disk apparatus that performs at least one operation of writing data on an optical disk and reading data recorded on the optical disk, said optical disk apparatus comprising:
said photoelectric converting device according to claim 1;
a light source that emits a beam; and
an optical system which splits the beam emitted by said light source into the first main beam, the first sub-beam, and the second sub-beam, and guides (i) the first main beam, the first sub-beam, and the second sub-beam that have been split to the optical disk, and (ii) the first main beam, the first sub-beam, and the second sub-beam that have been reflected from the optical disk to said photoelectric converting device.

11. An adjustment method, for use in the optical disk apparatus according to claim 10, for adjusting spot positions of a first sub-beam and a second sub-beam that are reflected from the optical disk and are emitted on the photoelectric converting device, said adjustment method comprising:
converting, using each of the second current-voltage converting circuits, a sum of (i) the current converted by the corresponding one of the second photoreceptors and (ii) the current converted by a corresponding one of the third photoreceptors to a first voltage signal, and transmitting the first voltage signal when each of the switching circuits selects the current converted by the corresponding one of the second photoreceptors;
converting, using each of the second current-voltage converting circuits, a sum of (i) the current obtained by amplifying or attenuating the current converted by the corresponding one of the second photoreceptors and (ii) the current converted by the corresponding one of the third photoreceptors to a second voltage signal, and transmitting the second voltage signal when each of the switching circuits selects the current amplified or attenuated by a corresponding one of the current amplifying circuits;
calculating a subtraction signal for each of the second current-voltage converting circuits by subtracting the first voltage signal from the second voltage signal or the second voltage signal from the first voltage signal, the first voltage signal and the second voltage signal being supplied by a same one of the second current-voltage converting circuits; and
adjusting at least one of a configuration of the optical system and a position of the photoelectric converting device using the subtraction signals so that the spot position of the first sub-beam reflected from the optical disk is in a middle of the second photoreceptors and the spot position of the second sub-beam reflected from the optical disk is in a middle of the third photoreceptors.
